(19) United States
(12) Patent Application Publication
(10) Pub. No.: US 2021/0231480 A1
(43) Pub. Date: Jul. 29, 2021

(54) Container

(71) Applicant: Romuald Yip, Illawong (AU)

(72) Inventor: Romuald Yip, Illawong (AU)

(21) Appl. No.: 17/257,245

(22) PCT Filed: Jul. 3, 2019
(86) PCT No.: PCT/AU2019/050701

§ 371 Date: Dec. 30, 2020

(30) Foreign Application Priority Data
Jul. 3, 2018 (AU) 2018902410
Sep. 14, 2018 (AU) 2018903478

(51) Int. Cl. G01F 11/26; B65D 23/10; B65D 1/06; B65D 47/26; B65D 83/06; B67D 3/00

(52) U.S. Cl. CPC G01F 11/263; B65D 23/102; B65D 1/06; B67D 3/0051; B65D 83/06; B67D 3/0045; B65D 47/261

(57) ABSTRACT

A container (10) having a hollow body (24) providing a space (11) to receive a liquid to be dispensed. The container (10) may also dispense granular material, pellets or powder. A valve assembly (31) of the container (10) is adapted to dispense a predetermined volume of the liquid.

### FIELD

The present invention relates to containers that dispense a measured volume of a flowable substance such as a granular or pellet material, a powder or liquid.

### BACKGROUND

There are numerous containers that are provided with valve mechanisms, with the valve mechanism being operable to open an outlet so that liquid may be drained from within the container.

There is also available containers that are provided with measuring caps and other means via which a user can measure a volume of liquid to be provided by the container.

A disadvantage of previous containers that provide for the dispensing of a desired volume, is that the user is required to operate the container to adjust the volume being dispensed to the desired volume.

### OBJECT

It is the object of the present invention to overcome or substantially ameliorate the above disadvantage.

### SUMMARY OF INVENTION

There is disclosed herein a container to dispense a predetermined volume of a flowable substance stored in the container, the container including:

a hollow body having an interior space to store the substance;

valve assembly communicating with the space so as to receive the substance therefrom; and wherein

the valve assembly includes:
a hollow chamber member at least partly enclosing a chamber, and having an inlet and an outlet, with the inlet providing for the flow of the substance from the space to the chamber, and the outlet providing for the delivery of the substance from the chamber and therefore container; and
a movable valve member operatively associated with the inlet to selectively close the inlet to thereby provide the delivery of said predetermined volume.

There is also disclosed herein a container to dispense a predetermined volume of a flowable substance stored in the container, the container including:

a hollow body having an interior space to store the substance;

a valve assembly communicating with the space so as to receive the substance therefrom; and wherein

the valve assembly includes:
a hollow chamber member at least partly enclosing a chamber, and having an inlet and an outlet with the inlet providing for the flow of the substance from the space to the chamber, and the outlet providing for the delivery of the substance from the chamber and therefore the container; and
a movable valve member operatively associated with the outlet to selectively close the outlet to thereby provide for the delivery of said predetermined volume.

There is also disclosed herein a container to dispense a predetermined volume of a flowable substance stored in the container, the container including:

a main volume; and,

a reservoir defining a separate volume to the main volume and connected thereto via a passage, the reservoir adapted to store the predetermined volume of the flowable substance, wherein the container has a first orientation whereby the main volume is in flowable communication with the reservoir via a passage, and a second orientation whereby the predetermined volume of the flowable substance is in flowable communication with an outlet from the container and the main volume is not in flowable communication with the reservoir.

There is still further disclosed herein a container to dispense a predetermined volume of a flowable substance stored in the container, the container including:

a main volume; and,

a reservoir defining a separate volume to the main volume, wherein is movable between:

a first position wherein an aperture in the reservoir is occluded and the reservoir is in flowable communication with an outlet of the container and,

a second position wherein the aperture in the reservoir provides a passage for flowable communication between the substance in the main volume and the reservoir for providing delivery of the predetermined the substance to the reservoir.

There is still further disclosed herein container to dispense a flowable substance, the container including:

a hollow body providing a first sub-chamber and a second sub-chamber separated by a wall;

a valve assembly communicating with the first sub-chamber and second sub-chamber for the delivery of the flowable substance from the first sub-chamber to the second sub-chamber;

an outlet for the delivery of the flowable substance from the second sub-chamber; and wherein

the valve assembly includes a movable valve member that is operable to connect the second sub-chamber with the first sub-chamber so as to provide for the delivery of the first substance from the first sub-chamber to the second sub-chamber, and a reservoir that receives the flowable substance from the movable valve member, with the reservoir being configured to determine said predetermined volume that is delivered to the outlet.

Preferably, the movable valve member is angularly movable between a first position preventing the flow of the substance between the first and second sub-chambers, and a second position permitting flow of the flowable substance from the first sub-chamber to the second sub-chamber.

There is still further disclosed herein a container to dispense a predetermined volume of a flowable substance, the container including:

a hollow body providing a main chamber to receive the flowable substance; and

a valve assembly mounted in the body and adapted to provide said predetermined volume, the valve assembly including:
a sleeve surrounding an interior, the sleeve having an aperture allowing the flowable substance to move from the chamber to the interior of the sleeve,
a movable valve member slidably mounted in the sleeve, the movable valve member providing a valve chamber, the movable valve member having at least one aperture aligned with the sleeve aperture to provide for the delivery of the flowable substance to the valve chamber, with the movable valve member having an outlet providing for delivery of a predetermined volume determined by the movable valve member, and wherein the movable valve member is movable between a first position providing for the delivery of a flowable substance to the valve member, and a second position preventing communication between the main chamber and the valve chamber and providing for the delivery of the flowable substance from within the valve chamber.

Preferably, the predetermined volume is adjustable volume.

Preferably, the movable valve member is moved linearly.

Preferably, the movable valve member is moved angularly.

There is also disclosed herein a container including:

a hollow body providing a chamber to receive a flowable substance;

a valve assembly mounted in the body, the valve assembly including:
a first sub-chamber;
a movable valve member located in the first sub-chamber;
a second sub-chamber, the second sub-chamber having an outlet via which a predetermined volume of the substance can be dispensed by the container, and wherein
the valve assembly includes a first aperture providing for the flow of the substance from the main chamber to the first sub-chamber;
a further aperture providing for the flow of the substance from the first sub-chamber to the second sub-chamber, and a movable valve member mounted in the first sub-chamber and movable relative thereto between a first position providing for the flow of the flowable substance from the main chamber to the first sub-chamber, and a second position providing for the flow of the flowable substance from the first sub-chamber to the second sub-chamber while prevent flow from the main chamber to the first sub-chamber.

### BRIEF DESCRIPTION OF DRAWINGS

Preferred forms of the present invention will now be described by way of example with reference to the accompanying drawings wherein:

FIG. 1 is a schematic sectioned side elevation of a container to dispense a predetermined volume of liquid;

FIG. 2 is a schematic sectioned side elevation of a further container to dispense a predetermined volume of liquid;

FIG. 3 is a schematic sectioned side elevation of the container of FIG. 2;

FIG. 4 is a schematic sectioned side elevation of a further container;

FIG. 5 is a schematic sectioned side elevation of the container of FIG. 4;

FIG. 6 is a schematic sectioned side elevation of a further container;

FIG. 7 is a schematic sectioned side elevation of the container of FIG. 6;

FIG. 8 is a schematic sectioned side elevation of a still further container;

FIGS. 9 to 14 are schematic sectioned side elevations of a further container;

FIGS. 15 to 19 are schematic sectioned side elevations of a modification of the container of FIG. 9;

FIGS. 20 to 23 are schematic sectioned side elevations of a still further container;

FIGS. 24 to 26 are schematic sectioned side elevations of a further container;

FIGS. 27 and 28 are schematic section side elevations of a still further container;

FIGS. 29 and 30 are schematic section side elevations of a still further container;

FIG. 31a is a schematic section side elevation of a still further container;

FIG. 31b is a schematic top view of the container of FIG. 31a;

FIG. 32a is a schematic section side elevation of the container of FIG. 31a in an alternative configuration.

FIG. 32b is a schematic top view of the container of FIG. 32a

FIG. 33 is a schematic section side elevation of a still further container;

FIG. 34 is a schematic section side elevation of the container of FIG. 33 in an alternative configuration;

FIG. 35 is a schematic section side elevation of a still further container;

FIG. 36 is a schematic section side elevation of the container of FIG. 35 in an alternative orientation;

FIG. 37 are schematic section side elevations of the container of FIG. 35 in an alternative orientation;

FIG. 38a is a schematic section side elevation of a still further container;

FIG. 38b is a schematic section side elevation of the container of FIG. 38a in an alternative orientation;

FIG. 38c is a schematic section side elevation of the container of FIG. 38a in an alternative orientation;

FIG. 38d is a schematic section side elevation of the container of FIG. 38a in an alternative orientation;

FIG. 38e is a schematic section side elevation of the container of FIG. 38a in an alternative orientation;

FIG. 38f is a schematic section side elevation of the container of FIG. 38a in an alternative orientation;

FIG. 38g is a schematic section side elevation of the container of FIG. 38a in an alternative orientation;

FIG. 39 is a schematic perspective of a valve member of the container of FIG. 39a;

FIG. 40 is a schematic side elevation of the container of FIG. 38a;

FIG. 41 is a schematic section side elevation of a still further container;

FIG. 42 is a schematic diagram illustrating a still further container, in a sequence of operations;

FIG. 43 is a schematic illustration of a still further container, illustrated in an operational sequence;

FIG. 44 is a schematic illustration of a still further container;

FIG. 45 is a schematic isometric view of an insert for the container of FIG. 44;

FIG. 46 is a schematic side elevation of the insert of FIG. 45;

FIG. 47 is a schematic end view of the insert of FIG. 45;

FIG. 48 is a schematic sectioned side elevation of a further container illustrated in various orientations;

FIG. 49 is a schematic isometric view of a valve of the container of FIG. 48;

FIG. 50 is a series of schematic sectioned side elevations of a further container illustrated in various orientations;

FIG. 51 is a schematic illustration of a further container in an operational sequence;

FIG. 52 is a schematic illustration of a still further container;

FIGS. 53, 54 and 55 are schematically illustrates a valve assembly employable in the container of FIG. 52;

FIG. 56 is a series of schematic side elevations of a further container;

FIGS. 57 and 58 are schematic side elevations and plan views of the valve of the container of FIG. 56;

FIG. 59 is a further schematic side elevation of the container of FIG. 56;

FIGS. 60, 61 and 62 are schematic side elevations and plan views of the container of FIG. 56;

FIGS. 63 and 64 are schematic side elevations of the valve of FIGS. 60, 61 and 62;

FIG. 65 is a schematic side elevation view of a container having the valve of FIGS. 60 to 64.

FIG. 66 is a schematic illustration of a further container;

FIG. 67 includes a schematic section side elevation of a valve of the container of FIG. 66;

FIG. 68 is a schematic view of the valve of FIG. 66;

FIG. 69 is a further schematic view of the valve of FIG. 66;

FIG. 70 is a sectioned illustration of the operation of a further container;

FIG. 71 is a schematic side isometric view of a valve of the container of FIG. 70;

FIG. 72 is a schematic sectioned side elevation of a further container;

FIG. 73 is a schematic view of a valve of the container of FIG. 72;

FIG. 74 is a schematic view of the valve of FIG. 72;

FIG. 75 is a schematic side elevation of a valve employed in the container of FIG. 72;

FIGS. 76 and 77 are schematic side elevations of a still further container;

FIG. 78 is a schematic side elevation of a valve employed in the container of FIGS. 76 and 77;

FIG. 79 is a schematic isometric of the valve as shown in FIG. 78;

FIG. 80 is a series of schematic sectioned side elevations illustrating a sequence of operations of a further container;

FIG. 81 is a schematic sectioned side elevation of a further container;

FIG. 82 is a schematic illustration of a valve employed in the container of FIG. 81;

FIG. 83 is a further schematic side elevation of the valve of the container of FIG. 81;

FIG. 84 is a schematic side elevation of a still further container;

FIG. 85 is a schematic sectioned side elevation of the container of FIG. 85; and

FIG. 86 is a further schematic sectioned side elevation of the container of FIG. 84.

### DESCRIPTION OF EMBODIMENTS

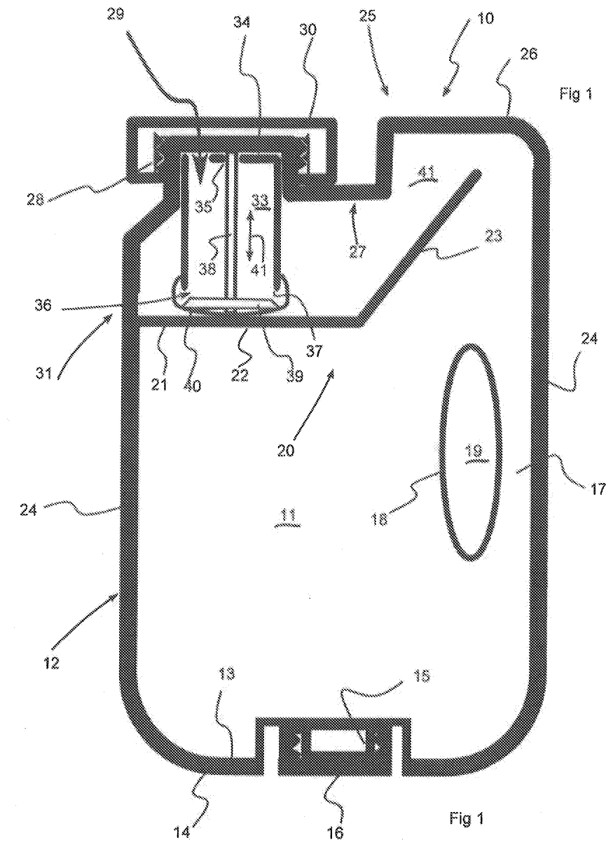

In FIG. 1 there is schematically depicted a container 10. The container 10 includes a hollow body 12 that provides a space 11 to receive and store a liquid to be dispensed by the container 10. Although the following embodiments will be described with reference to storing and dispensing a liquid at least some of the following embodiments, are also applicable to other flowable substances such as granular material, pellets and powder.

In this embodiment the body 12 has a bottom wall 13 that has a flat outer surface 14 upon which the container 10 can rest. In this embodiment the bottom wall 13 has a filling port 15 closed by a cap 16. The container 10 would be filled with liquid via the filling port 15.

Preferably, the body 12 is “crimped” so as to provide a handle 17. The body 12 has a crimped portion 18 providing an aperture 19 through which a user's hand may pass to grip the handle 17.

The body 12 is further crimped to provide an internal wall 20 having a first inclined wall portion 21 providing a surface 22, that is inclined to the horizontal, and in particular is inclined by an acute angle to the surface 14.

The wall 20 also has an inclined wall portion 23 that extends upwardly from the wall portion 21, and is inclined to the surface 14 by an acute angle.

The body 12 also has one or more side walls 24 that extend upwardly from the bottom wall 13. Preferably each wall 14 is generally perpendicular to the bottom wall 13.

The body 12 also has an upper wall 25 providing a first planar portion 26 that extends to a step portion 27. The step portion 27 aids in providing a threaded neck 28 that surrounds an outlet 29. The threaded neck 28 is threadably engaged by a cap 30 that is operable to open and close the outlet 29.

Fixed to internal surfaces of the neck 28 is a valve assembly 31.

The valve assembly 31 includes a hollow chamber member 32 that surrounds and provides a chamber 33. The chamber member 32 also has an end flange 34 having an aperture 35.

The outlet 29 is located adjacent the upper portions of the chamber member 32, while located at the lower portions of the chamber member 32 is an inlet 36 provided by a valve seat 37.

Mounted by means of a stem 38, slidably located in the aperture 35, is a movable valve member 39. The movable valve member 39 is movable relative to the seat 37 to open and close the inlet 36.

Fixed to the member 32 and engaged with the stem 38, and/or movable valve member 39, is a resilient member (spring) 40, that urges the stem 38 and movable valve member 39 in the direction 41, that is a direction closing the inlet 36.

The stem 38 projects into the aperture 35, and abuts the cap 30 to retain the movable valve member 39 in the open position. When in the open position of the movable valve member 39, liquid is allowed to flow from the sub-chamber 41, separated from the remainder of the interior of the body 12 by the wall 20, into the chamber 33.

With the chamber 33 charged with liquid, a user holds the container 10 so that the body 12 is oriented upwardly, and removes the cap 30. Upon removing the cap 30, the spring 40 urges the movable valve member 29 to close the inlet 36. Therefore, no further liquid can enter the chamber 33. Thereafter, the user tilts the container 10 and empties the chamber 33. Thereafter, the user places the cap 33 back on the neck 28 to again displace the movable valve member 39 to the open position. Liquid contained in the sub-chamber 41 can then again flow into the chamber 33.

In operation of the above described container 10, the valve assembly 39 dispenses a predetermined volume of the liquid.

Preferably the top wall 27 provides a generally horizontal surface (together with the cap 30) upon which other containers 10 may be stacked or engage machinery that would assist in filling of the container 10 via the inlet port 15.

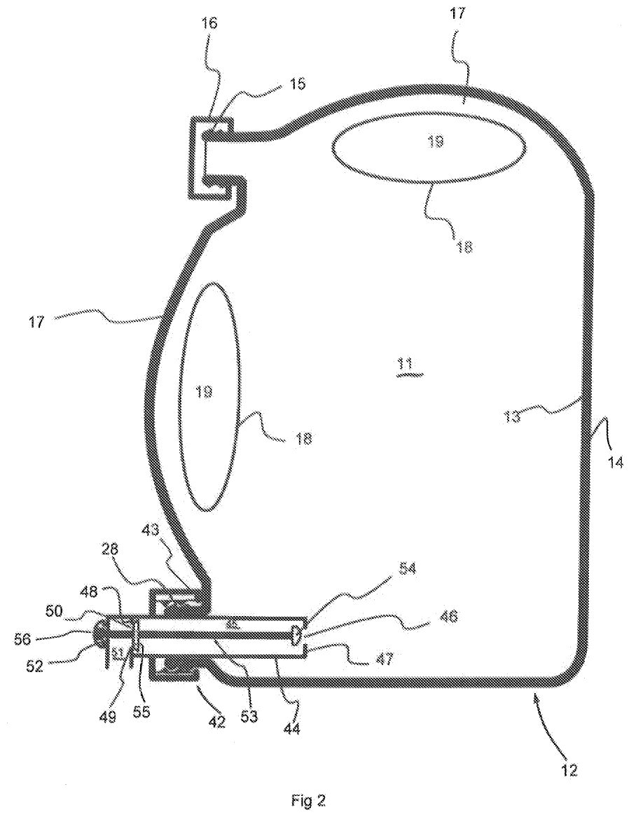

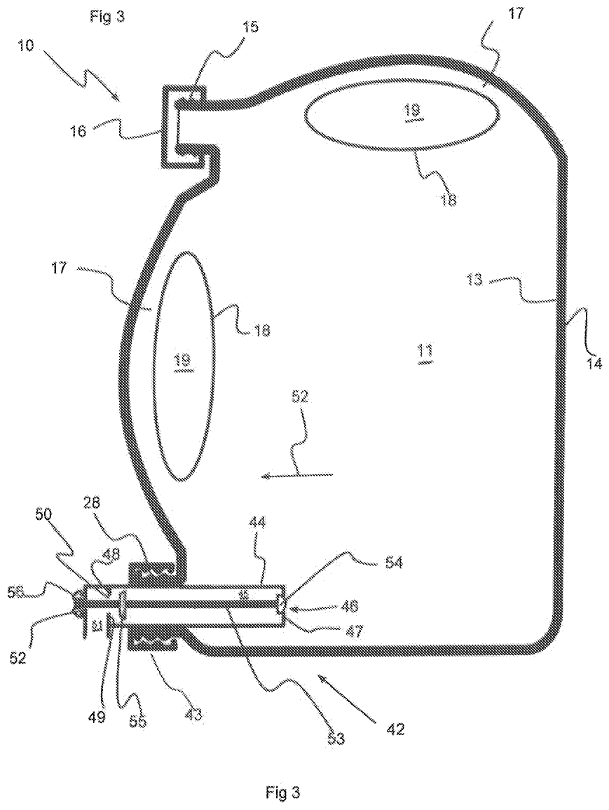

In the embodiment of FIGS. 2 and 3, the container 10 is provided with two handles 17, with the filling port 15 moved from a bottom wall portion to an upper wall portion.

The container 10 of FIGS. 2 and 3 has a valve assembly 42 that is mounted on the threaded neck 28 so as to close the outlet 29. In particular, the valve assembly 42 has an internally threaded flange 43 that is engaged with the neck 28.

The valve assembly 42 has a hollow chamber member 44 that surrounds and generally encloses a chamber 45. The chamber member 44 provides an inlet 46 that is surrounded by a valve seat 47, while an internal wall 48 provides valve seat 49 surrounding an outlet 50. Extending from the outlet 50 is an outlet duct 51.

Slidably engaged in an aperture 52 of the member 44, is a stem 53. Fixed to the stem 53 is a first movable valve member 54 that is operable to close the inlet 46, and a further movable valve member 55 that is operable to close the outlet 50.

An upper end extremity of the stem 53 is fixed to a resilient cap 56. Upon being deformed, the resilient cap 56 urges the stem 53 to move in the direction 57 to close the outlet 50.

The movable valve members 54 and 45 are spaced that either the valve member 55 is closing the outlet 50, or the valve member 54 is closing the inlet 46.

With the cap 56 released, the movable valve member 55 is located so as to engage the seat 49 and close the outlet 50.

In operation of the above described container 10, a user tilts the container 10 until the chamber 55 is full. Thereafter, the user depresses the cap 56, moving the movable valve member 54 to close the inlet 46. The liquid located in the chamber 45 is then allowed to exit via the outlet 50 and outlet duct 51. Upon the user then releasing the cap 56, the movable valve element 55 closes the outlet 50 while the movable valve member 54 opens the inlet 46 so that further liquid may be delivered to the chamber 45.

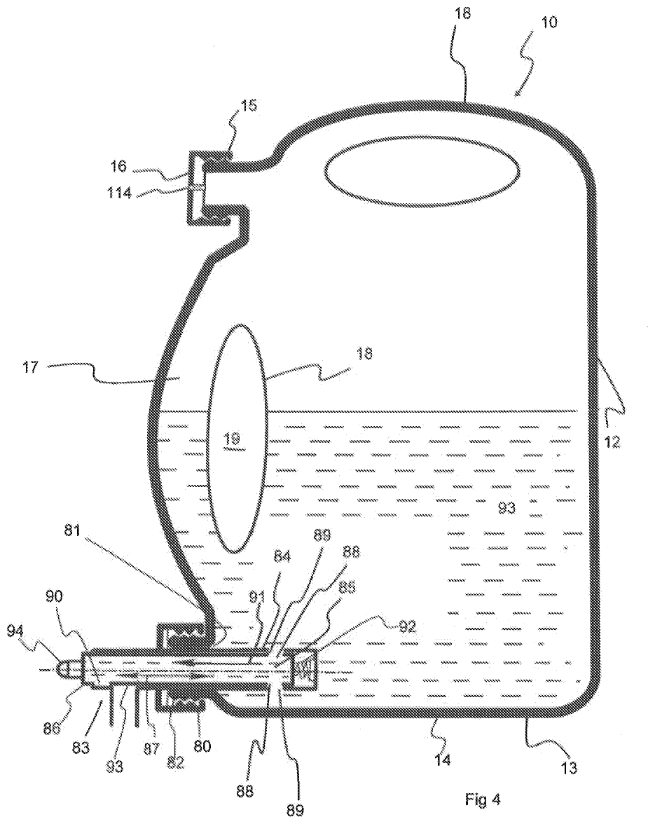

In the embodiment of FIGS. 4 and 5, the container 10 has an annular externally threaded flange 80, that surrounds a passage 81. Located in the passage 81 and secured thereto by a threaded flange 82 is a valve assembly 83. The valve assembly 83 includes a hollow chamber member 84 that provides a chamber 85. Slidably located internally of the member 84 is a movable valve element 86 that can be moved in the direction 87. The valve member 86 has a first pair of apertures 88 that are alignable with a pair of passages 89 formed in the member 84. The movable valve member 86 has a further aperture 90 that is spaced from the apertures 88 in the direction 91.

A spring 92 is positioned between the movable valve member and member 84, to urge the movable valve member 86 in the direction 91.

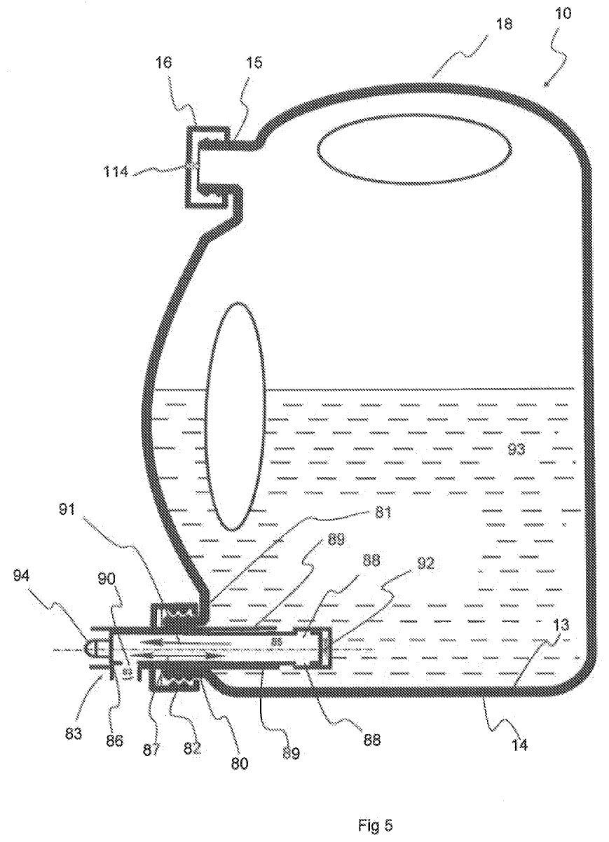

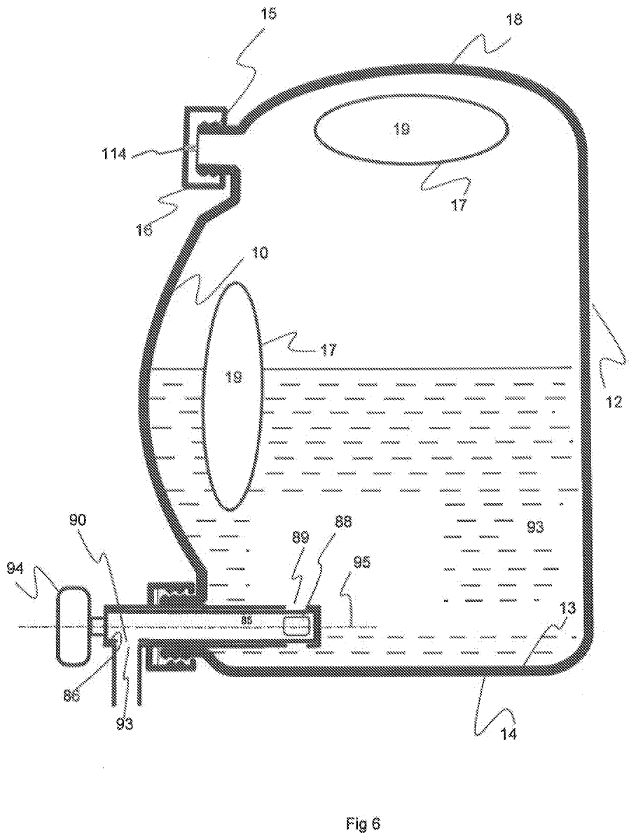

With the movable valve member 86 in the position shown in FIG. 6, liquid 93 stored in the container 10 is allowed to flow and enter the chamber 85. This is done via the aligned passages 80, 88 and 89.

The chamber member 84 has an outlet 93 that is alignable with the aperture 90.

With the spring 92 urging the movable valve member 86 in the direction 91, the apertures 88 and 89 are aligned so that the chamber 85 fills. A user, then presses on the knob 94 of the movable valve member 86, to move the movable valve member 86 in a direction opposite the direction 91. This compresses the spring 92, and moves the apertures 88 from alignment with the passages 89. Accordingly, no further liquid can enter the chamber 85. However, the aperture 90 is aligned with the outlet 93 so that the chamber 85 is drained.

Upon the user releasing the movable valve member 86, the movable valve member 86 moves in the direction 91 to close the outlet 93, and to again align the apertures 88 and 89. Accordingly, the chamber 85 is recharged.

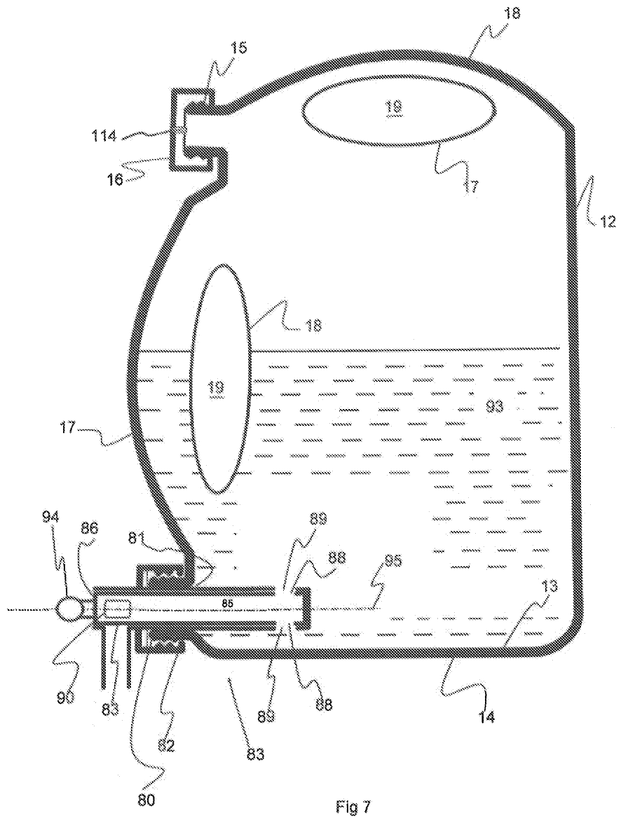

In the embodiment of FIGS. 6 and 7, the movable valve member 86, rather than being moved in the direction 83, is moved angularly about the axis 95 to align the aperture 90 with the outlet 93, or align the apertures 88 with the apertures 89. When the apertures 88 and 89 are aligned, the aperture 90 is not aligned with the outlet 93. When the aperture 90 is aligned with the outlet 93, the apertures 88 and 89 are not aligned.

The apertures 88 are displaced angularly about the axis 95 by approximately 90° from the aperture 90. Accordingly, liquid is allowed to enter the chamber 85, or leave the chamber 85.

In the embodiments of FIGS. 4 to 7, the container 10 is provided with a vent 114 to allow air to enter the container 10 when being drained. The vent 114 may include a one-way valve, and may be located in cap 16 or body 12.

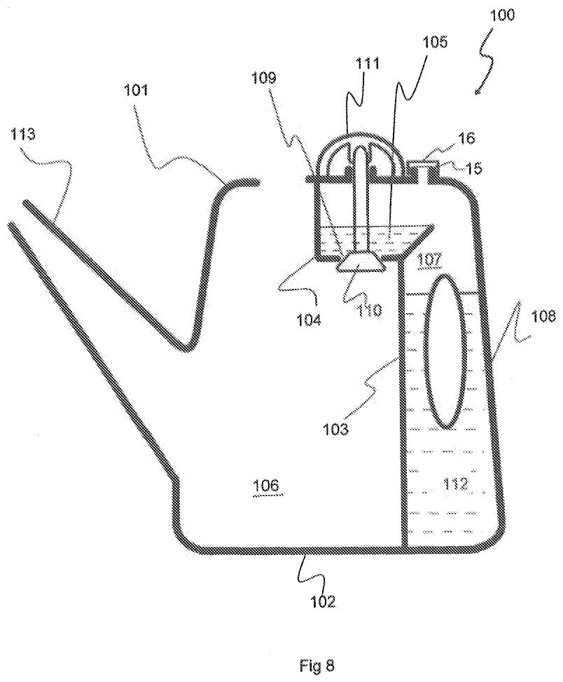

In FIG. 8 there is schematically depicted a container (watering can) 100. The container 100 includes a hollow body 101 that has a bottom wall 102 that is flat and upon which the container 100 may rest. The body 101 is crimped so as to have a generally upright internal wall 103 and a further internal wall 104 that provides a chamber member. The wall 104 at least partly encloses a first sub-chamber 105.

The walls 103 and 104 divide the container 100 internally into a second sub-chamber 106 and a third sub-chamber 107. An inlet port 15 is provided via which the liquid 112 is delivered to the sub-chamber 107. The port 15 is closed by a cap 16.

The container 100 is also provided with a handle 108.

The wall 104 is provided with a valve opening 109 that can be closed by a movable valve member 110. The movable valve member 110 is coupled at its upper end to a flexible cap 111 that can be depressed to move the movable valve member 110 from engagement with the wall 104 to open the valve opening 109.

In use of the above described preferred embodiment, the movable valve member 110 is urged to close the valve opening 109 by the cap 111. When the valve opening 109 is closed, a user tilts the container 100 to cause the liquid 112 to flow from the sub-chamber 107, to the sub-chamber 105.

With the container 100 then upright, a user depresses the cap 111 to move the valve member 110 from the closed position to the open position in respect of valve opening 109. Liquid in the chamber 105 is then allowed to flow to the sub-chamber 106.

The user then releases the cap 111, so that the valve opening 109 is then closed by the valve member 110.

By operation of the above described container 10, a user can charge the sub-chamber 107 with a predetermined volume of liquid. This can then be mixed with water or another liquid delivered to the sub-chamber 106, with the contents of the sub-chamber 106 being delivered by means of a spout 113. The spout 113 can be replaced with pouring spout closed by a removable cap.

The above describe preferred embodiments have the advantage that they dispense a predetermined volume of liquid.

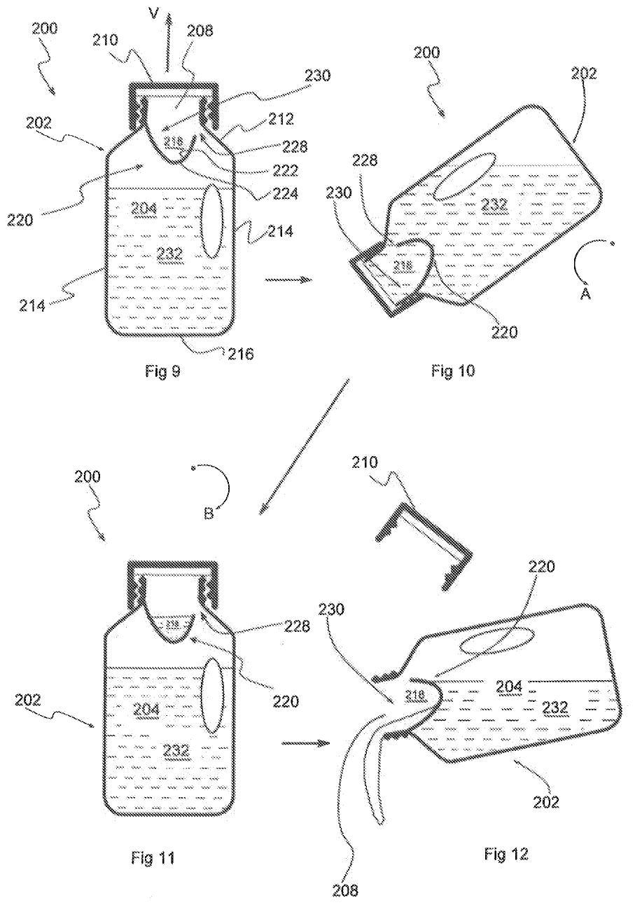

FIGS. 9 to 26 show containers for dispensing a predetermined quantity of a flowable medium, preferably a liquid such as a surfactant concentrate or a fertilizer concentrate, where the container need not include a valve assembly.

Referring to FIG. 9, the container has a hollow body defining an internal space for storing the liquid.

The hollow body 202 of the container 200 has a neck portion 206 defining an outlet 208, the neck portion 206 being threaded to receive a cap 210 for occluding the outlet 208. The hollow body 202 of the container 200 further comprises a shoulder portion 212 locating adjacent to the neck portion 206, said shoulder portion 212 connecting to sidewalls 214 of the hollow body 202. The hollow body 202 further comprises a bottom wall 216 connecting with the side walls 214. The side walls 214, bottom wall 216, shoulder portion 212 and the neck portion 206 in combination with the cap 210 enclose the internal space 204.

Located within the internal space 204 is a reservoir 218 defined by a hollow reservoir member 220. The reservoir 218 is adapted to store a volume of liquid separately from a main volume 232 of the internal space 204. Said main volume 232 in this embodiment locating vertically beneath the reservoir 218 and being defined by a partial extent of the side walls 214 and the bottom wall 216.

The reservoir 218 and the main volume 232 are in communication via a passage 228. By this arrangement, the orientation of the container 200 may by altered such that liquid can freely flow from the main volume 232 to the reservoir 218 via the passage 228 thereby charging the reservoir 218 with the liquid.

The reservoir 218 is in flowable communication with the outlet 208 with said flowable communication being provided separately from the passage 228 connecting the reservoir 218 and the main volume 232. By this arrangement, the orientation of the container 200 can be adjusted such that the liquid charged to the reservoir 218 can freely flow to the outlet 208 and hence out of the internal space 204 of the container 200 when the cap 210 is removed. The orientation whereby liquid can flow from the reservoir 218 to the outlet 208 is also configured such that liquid cannot flow from the main volume 232 to the reservoir 218 via the passage 228. By this arrangement, the container 200 allows for a predetermined volume of liquid charged to the reservoir 218 to be dispensed without also dispensing the liquid from the main volume 232.

The hollow reservoir member 220 has a dished or generally conical form, although other arrangements are possible. The reservoir member 220 has a low portion 224, which may locate generally below and spaced from the outlet 208, with side walls 222 extending from the low portion 224 to the shoulder portion 212. As depicted, the side walls 222 may incline sharply from the low point 224 toward the shoulder portion 212, the incline being generally acute in comparison to the vertical, with the vertically upwards direction indicated by arrow V. The upper region of most of the reservoir member 220 sidewalls 222 connect with the shoulder portion 212 of the container 200, with at least a portion not connecting with the shoulder portion 212 but rather leaving a gap between the sidewalls 222 and the neck portion 212, thereby defining the passage 228 between the reservoir 218 and the main volume 232. The part of the side wall 222 terminating short of the shoulder portion defines a lip 226 of the side wall 222.

The side wall 222 of the reservoir member 220 opposing the passage 228 connects continuously with a surface 230 in flowable communication with the outlet 208. Specifically, in this embodiment, the upper part of the reservoir member 220 opposite to the passage 228 transitions to the shoulder portion 212 and then the neck portion 206 of one side of the container 200, defining a channel 230 for liquid in the reservoir to flow toward the outlet 208

FIGS. 9 to 17 show an embodiment of the container 200 in differing orientations to describe use of the container 200 in dispensing a predetermined volume of liquid. FIG. 11 shows the container 200 in an upright orientation with liquid contained in the main volume 232 of the internal space 204, and with the reservoir 218 being empty. In this upright position, the container 200 can be stably rested on its bottom wall 216.

In FIG. 10, the container 200 has been tilted in a first direction indicated by arrow A, such that the liquid in the main volume 232 reaches the passage 228 and flows through the passage 228, flooding the reservoir 218 as well as the neck portion 206. The cap 210 is in place on the neck 206 portion thereby occluding the outlet 208 prevent liquid from flowing therethrough. The degree of tilt or angle at which the container 200 is tilted in the first direction so that liquid can freely flow through the passage 228 from the main volume 232 may be termed the minimum charging angle.

In FIG. 11, the container 200 has been tilted in a second direction indicated by arrow B back to the upright orientation of FIG. 11, with the second direction being opposite the first direction. As the container 200 is tilted in the second direction, liquid is retained by the reservoir 218, with some excess liquid flowing through the passage 228 back to the main volume 232. Typically, the fill height of the liquid in the reservoir 218 would be up to the lip 226 defining the bottom of the passage 228, which defines the predetermined volume in this embodiment. However, in some other embodiments, the fill height would be lower than the lip 226, as governed by the particular configuration of the various walls/surfaces of the reservoir 218 and container 200. Regardless, the amount of liquid charged to the reservoir 218 after the container is titled in the first direction past the minimum charging angle and subsequently returned to the upright orientation is termed the predetermined volume.

In FIG. 12, the cap 210 is removed from the neck portion 206, and the container 200 has been tilted in the first direction such that the liquid flows along the channel 230 provided by the surface 230 in flowable communication with the outlet 208, thereby dispensing the predetermined volume of liquid from the container through the outlet 208. The angle at which the container is tilted in the first direction so that substantially all liquid can flow from the reservoir 218 to the outlet 208 via the surface 230, but the liquid in the main volume 232 does not reach the passage 228 may be termed the maximum dispensing angle.

Notably, when the container 200 is at the maximum dispensing angle, the liquid in the main volume 232 of the internal space 204 has not reached the passage 228, so there is no flow from the main volume 232 through the passage 228. Accordingly, the maximum dispensing angle is less than the minimum charging angle, so that the predetermined volume can be dispensed from the container 200 while keeping the liquid of the main volume 232 within the container 200. Otherwise stated, the maximum dispensing angle requires less tilt from the upright position (indicated by arrow V in FIGS. 1 to 4) than the minimum charging angle. Further, while the minimum charging angle and the maximum dispensing angle may change depending on the amount of liquid in the main volume 232, the amount of tilt from the upright position will remain greater for the maximum discharge angle compared to the minimum charging angle.

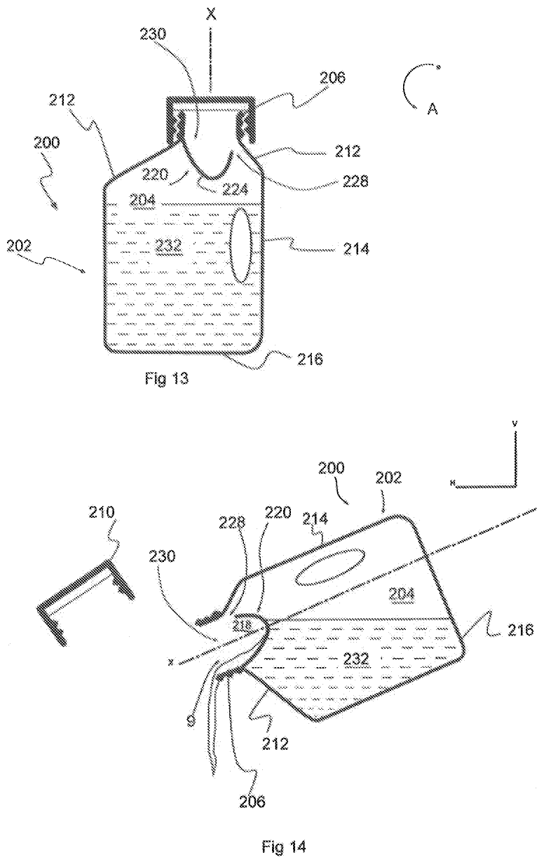

Referring now to FIGS. 13 and 14, shown is an embodiment where the container 200 is asymmetrical about an axis X through the outlet 208. Here, the shoulder portion 212 opposite to the passage 228 is longer than the shoulder portion 212 adjacent to the passage 228. Otherwise stated, the shoulder portion 212 opposite to the passage 228 extends further from the axis X than the shoulder portion 212 adjacent to passage 228, or equivalently, the shoulder portion 212 opposite to the passage 228 extends further from the neck portion 206 than the shoulder portion 212 adjacent to passage 228. This arrangement increases the volume of liquid storable within the main volume 232 when the container 200 is at the maximum dispensing angle. The extended shoulder portion 212 is also in the direction of the first direction A, thereby providing indication to the user as to which way to tilt the container 200 to charge the reservoir 218.

As evident from FIG. 14, the minimum charge angle involves the surface 230 being brought further below the horizontal as indicated by arrow H than is the case for then maximum dispensing angle when the liquid in the main volume 232 reaches the passage 228. Otherwise stated, axis X is at a greater angle from the horizontal H at the minimum charging angle compared to the maximum dispensing angle.

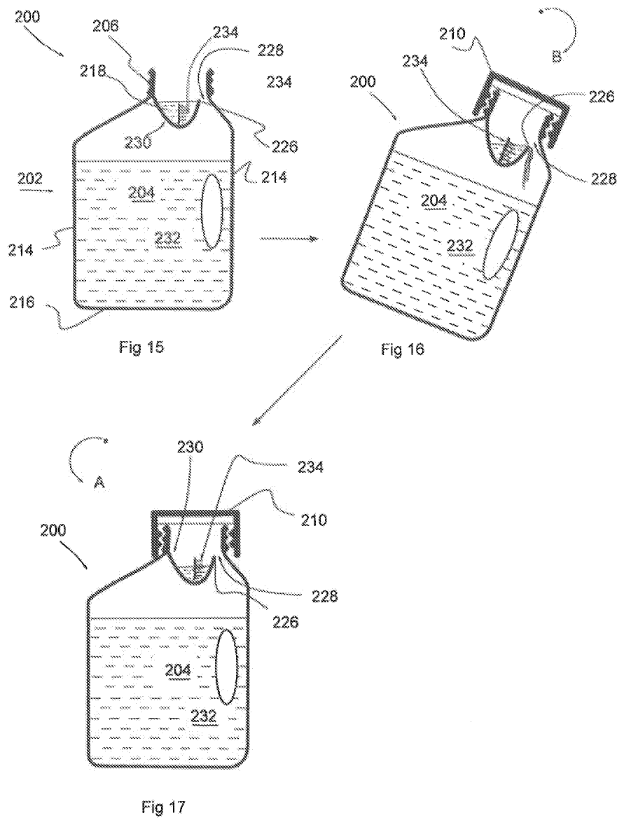

Referring now to FIGS. 15 to 19, shown is an embodiment where the predetermined volume is selectable to dispense differing predetermined volumes as required by a user.

FIG. 15 shows a similar embodiment to that of FIGS. 13 and 14 with the reservoir 218 charged with liquid up to the level of the lip 226. Here, the reservoir 218 is marked with indicia 234 indicating the volume of liquid at different levels of the reservoir 218. At least a portion of the side wall 214 of the container 220, as well as a corresponding portion of a sidewall of the reservoir member 220 are non-opaque so that a user can sight the liquid level in the reservoir 218 as well as the indicia 234.

Referring to FIG. 16, a user can tilt the container 200 so that liquid spills over the lip 226 of the reservoir 218 thus decreasing the volume of liquid present therein. As depicted, the container 200 is tilted in the second direction B so the charged liquid can drain from the reservoir 218. The user can repeat this process as necessary, recharging the reservoir as hereinbefore described if necessary, until a required predetermined volume of liquid is present in the reservoir 218 as measured by the indicia 234 marking volume. FIG. 19 shows the container 200 in an upright position with the measured pre-determined volume of liquid in the reservoir 218 ready to be dispensed by removing the cap 210 and tilting the container 200 in the first direction A up to the maximum dispensing angle so that the liquid can drain from the reservoir 218 to the outlet 208 along the channel 230 provided by the surface 230.

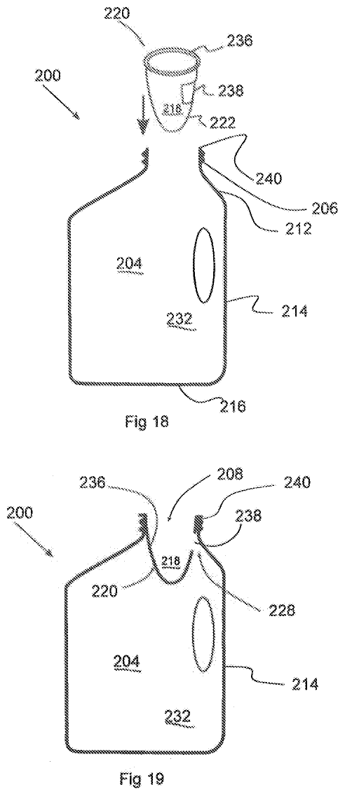

In the FIGS. 9 to 17, the internal walls defining the hollow reservoir member 220 can be formed by “crimping” the hollow body 202 of the container 200. FIGS. 18 and 19 show an alternative embodiment where the hollow reservoir member 220 is separately formed from the container 200 and is removable from within the internal space 204. Here, the hollow reservoir member 220 is again in the form of rounded cone with a flanged rim 236 at the upper extent of the side walls 222, said flanged rim 236 seating against a rim 240 of the neck portion 206 such that an open top of the reservoir member 220 defines the outlet 208. An aperture 238 is formed into the sidewall 222 of the hollow reservoir member 220 such that when the hollow reservoir member 220 is in a fitted condition with the flanged rim 236 seated against the rim 240 of the neck portion 206, the aperture 238 provides the passage 228 between the reservoir 218 and the main volume 232. This embodiment may be advantageous in that the hollow reservoir member 220 may be removed from the internal space 204 allowing for easy filling of the container 220 with liquid. In a further embodiment, hollow reservoir members 220 of varying arrangement may be supplied so that the user can select a different reservoir member 220 for dispensing a different predetermined volume.

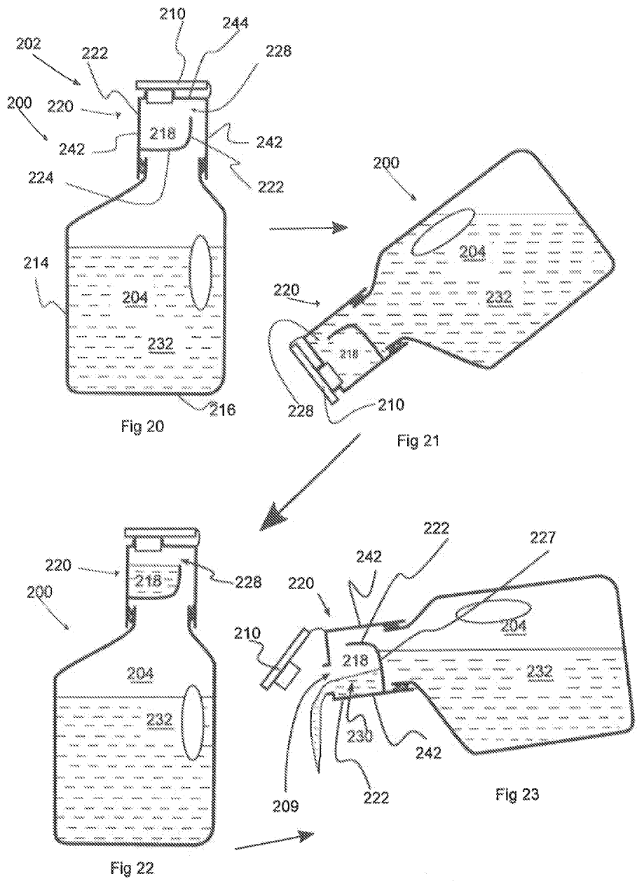

Referring to FIGS. 20 to 23, the reservoir member 220 is adapted for attachment the neck portion 206 to locate generally above the neck portion 206 in a direction opposite to the main volume 232. Specifically, the reservoir member 220 is oppositely located to the neck portion 206 with respect to the shoulder portion 212 so that the reservoir member 220 locates above the neck portion 220 when the container is upright and resting on the bottom wall 216. The reservoir member 220 has an internal thread for engagement with the threaded neck portion 206, and has external sidewalls 242 forming part of the hollow body 202 of the container 200, with an internal bottom wall 224 (providing the low portion 224) and an internal side wall 242 defining the reservoir 218 in conjunction with a portion of the external sidewall 242 of the reservoir member opposite to the passage 228. Here, the said passage 228 is formed by a gap between the internal sidewall 242 and a top wall 244 of the reservoir member 220. The top wall 244 of the reservoir member 220 has an aperture forming the outlet 208 of the container which is occluded by a hinged flip-lid style cap 210 that provides an interference fit with the outlet 208. The aperture forming the outlet 208 communicates with the reservoir 218 by a surface 230 formed by an upper extent of the sidewall 242 internal of the reservoir member 220.

The sequence of FIGS. 20 to 23 show the differing orientations required to first charge the reservoir 218 with liquid, and then dispense liquid from the reservoir 218 though the outlet 208 in a similar manner to FIGS. 11 to 14. Notably, the minimum charging angle is less than the maximum dispensing angle, with the internal wall forming low portion 224 of the reservoir member 220 presenting a barrier between liquid in the main volume 232 and the outlet 208 when the liquid is being dispensed from the container 200 at the maximum dispensing angle with the liquid not reaching the passage 228.

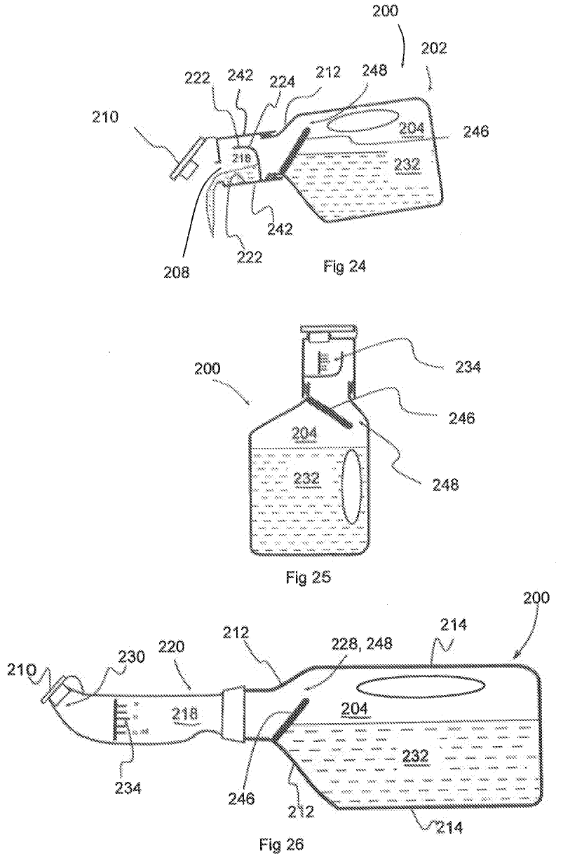

FIG. 24 shows an embodiment similar to that of FIGS. 20 to 23, wherein an internal wall 246 termed the secondary barrier 246 is provided between the passage 228 and the main volume 232. Here, the internal wall 246 connects with the neck portion 206, extending into the internal space 204 at an incline away from the reservoir member 220. The secondary barrier 246 only extends partially through the internal space 204 leaving a gap 248 between the terminal part of the secondary barrier 246 and an adjacent part of the hollow body 202 so that liquid can flow past the secondary barrier 246 through the gap 248 in certain orientations of the container 200. The secondary barrier 246 is provided to increase the maximum dispensing angle before liquid in the main volume 232 reaches the passage 228. In this embodiment, the secondary barrier 246 is formed by “crimping” the hollow body 202 container 200, though other arrangements are equally permissible.

FIG. 25 shows an alternative embodiment of FIG. 24, where the hollow reservoir member 220 is nonopaque and provided with indicia 234 indicating the volume of liquid in the reservoir 218, thereby allowing a user to determine and select the predetermined volume of liquid in the reservoir 218 in a manner equivalent to hereinbefore described in relation to FIGS. 17 to 19.

The embodiments of FIGS. 20 to 25 may be advantageous in that the reservoir member 220 is integral with a cap 210 which can be separated from the remainder of the container 200. Accordingly, it may be manufactured and supplied separately for use with ordinary bottles and the like.

FIG. 26 shows an embodiment wherein the reservoir 218 is formed by the hollow reservoir member 220 in conjunction with the secondary barrier 246. In this embodiment, the container 200 is adapted to orientate horizontally rather than vertically, resting on a sidewall 214 rather than in an upright position resting on a bottom wall 216. The hollow reservoir member 220 is attached to the neck portion 206. The secondary barrier 246 locates in the internal space 204 and extends from the shoulder portion 212 towards an opposing wall 214 of the hollow body 202 with an incline away from the reservoir member 220. The passage 228 is thus formed by the gap 248 between the terminal part of the secondary barrier 246 and the adjacent part of the hollow body 202. Due to the particular arrangement of this container 200, once the reservoir 218 is charged with liquid it can be seated on its sidewall 214 adjacent to the extended shoulder portion 212 (providing the asymmetry hereinbefore described) without the charged liquid reaching the level of the passage 228 or the outlet of the container 208, said outlet 208 being angled upwardly. Such an arrangement may provide for a shallower dispensing angle than earlier described embodiments.

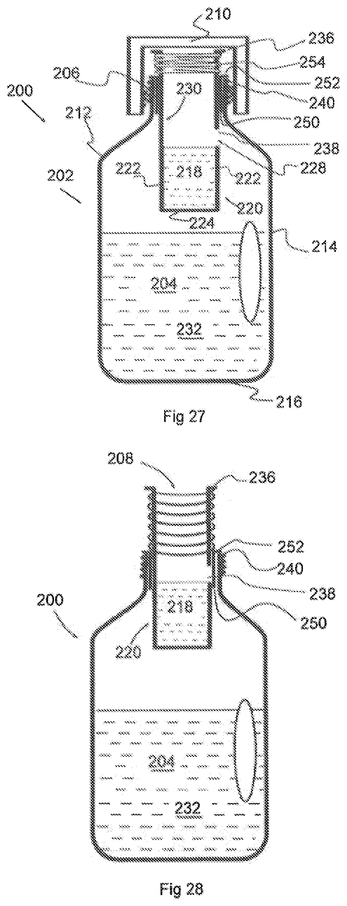

FIGS. 27 and 28 show an alternative embodiment where a collar member 250 locates internally of the neck portion 206, said collar member 250 having a flanged upper part 252 to seat against a rim 240 of the neck portion 206. The hollow reservoir member 220 is in the form of a cylindrical member having an open top forming the outlet 208 of the container 200, and an aperture 238 in a sidewall forming the passage 228. The reservoir member 220 has a flanged upper portion 236, with a biasing element in the form of a spring 254 acting between the flange 252 of the collar member 250 and the flange 236 of the reservoir member 220. The reservoir member 220 is thereby movable between a first position (shown in FIG. 28) where the aperture 238 of the reservoir member 220 locates adjacently to a portion of the collar member 250 and is occluded thereby, and a second position (shown in FIG. 27) where the aperture 238 of the reservoir member 220 locates away from the collar member 238 and communicates with the main volume 232 of the container 200 thereby forming the passage 228 connecting the reservoir 218 and the main volume 232.

When a cap 210 is threaded to the neck portion 260 as shown in FIG. 27, the reservoir member 220 is moved downwardly into the container 200 against the bias of the spring 254 and into the second position. When in the second position, an upper part of the reservoir member 220 is in abutment with the cap 210 preventing the reservoir member 220 from moving upwardly into the first position. With the reservoir member 220 in the second position of FIG. 27, the container 200 can be tilted so that liquid in the main volume 232 reaches the level of the passage 228 and flows into the reservoir 218, and subsequently, be returned to an upright position so that the reservoir 218 is charged up to the level of the passage/aperture 228, 238. With the reservoir 218 thus charged, the cap 210 may be removed from the neck portion 206 so that the reservoir member 220 moves upwardly and into the second position under the influence of the spring 254. With the reservoir member 220 in the second position, the aperture 238 seals against a portion of the collar member 250 thus occluding the passage 228 such that the container 200 can be tilted to dispense the liquid from the reservoir 218 along a surface 230 provided by an extension of the side walls 222 and through the outlet 208 with the contents of the main volume 232 remaining within the internal space 204.

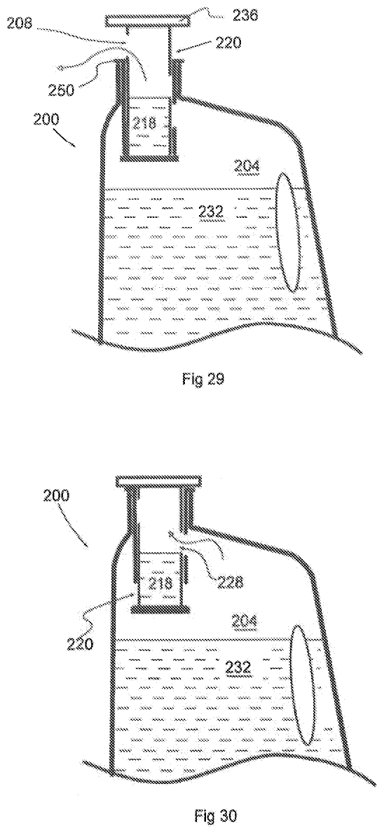

FIGS. 29 and 30 show a similar embodiment to FIGS. 27 and 28 where the reservoir member 220 has a friction fit with the collar member 250 so that the reservoir member 220 is pushed and pulled between the first and second positions. Here, the top portion of the reservoir member 220 is enclosed and is flanged 236 to abut with the collar member 250 in the first position (FIG. 30). Similarly, the bottom of the reservoir member 220 is enclosed and flanged to abut with the bottom of the collar member 250 in the second position (FIG. 29). The reservoir member 220 has two apertures in opposing sidewalls. When in the first position, the lower aperture aligns with an aperture in the collar member 250 to form the passage 228, whereas the upper aperture seals against the collar member 250. When in the second position, the lower aperture of the reservoir member 220 seals against the collar member 250, whereas the upper aperture communicates externally of the container thereby forming the outlet 208.

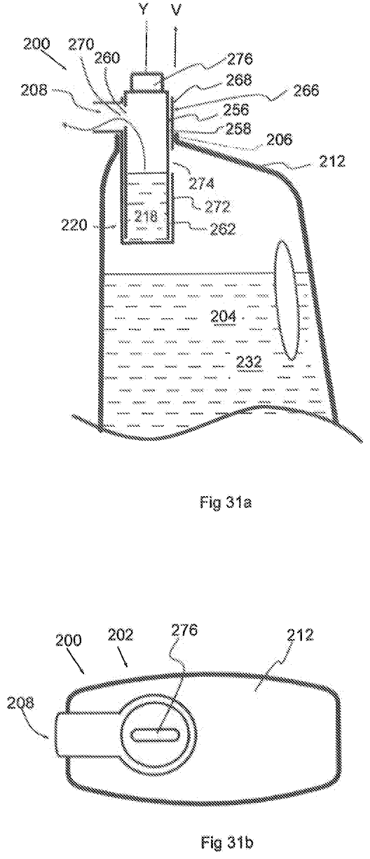

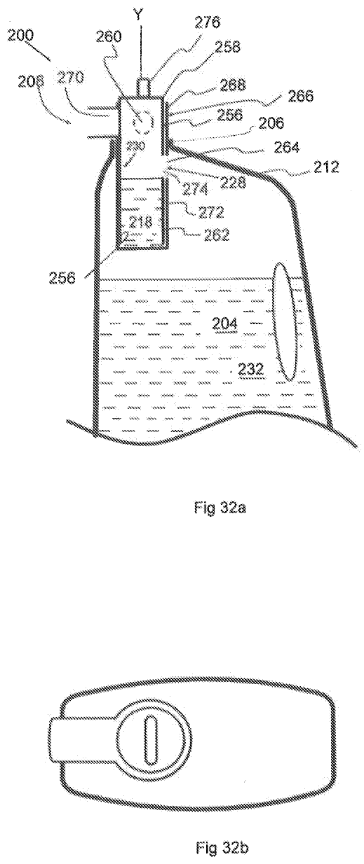

FIGS. 31a and 32a show a further embodiment where the reservoir member 220 is a two-part assembly comprising an inner member 256 and an outer member 266. Both the inner member 256 and the outer member 266 are generally cylindrical in configuration, with the inner member 256 locating within the outer member 266 and being angularly movable relative thereto about an axis Y. In the depicted embodiment, the axis Y corresponds to a long axis of the reservoir member 220, which would be in generally vertical alignment (indicated by arrow V) when the container 200 is seated on its bottom wall (not shown).

The reservoir member 220 locates through the neck portion 206 of the container 200, with an upper portion 258, 268 locating on an opposite side of the neck portion 206 to a lower portion 262, 272, the lower portion 262, 272 generally locating between side walls 214 of the hollow body 202 defining the container 200.

The lower portion 262, 272 of both the inner member 256 and the outer member 266 have apertures 264, 274, which may be aligned by angularly moving the inner member 256 relative to the outer member 266. When the apertures 264, 274 of the lower portion 262, 272 of both the inner 256 and outer members 266 are aligned, they form a passage 228 connecting the reservoir 218 defined by the reservoir member 220 with the main volume 232 of the container.

The upper portion 258, 268 of both the inner 256 and outer 266 members are also configured with an aperture 260,270, which may be aligned by angularly moving the inner member 256 relative to the outer member 266. When the apertures 256,266 of the upper portion 256.268 of both the inner 256 and outer 266 members are aligned, they form an outlet 208 from the container 200 for dispensing a predetermined volume of liquid in the reservoir 218. The orientation of the apertures 260, 264 of the inner member 256 are arranged such that when the upper aperture 260 is aligned with the upper aperture 270 of the outer member 266, the lower aperture 264 of the inner member 256 is not aligned with the lower aperture 264 of the outer member 266. By this arrangement, the passage 228 is occluded as shown in FIG. 31a Similarly, when the lower aperture 264 of the inner member 256 is aligned with the lower aperture 274 of the outer member 266 to define the passage 228, the upper apertures 260,270 of the inner 256 and outer member 266 are out of alignment thereby occluding the outlet 208 as shown in FIG. 32a.

The embodiments of FIGS. 31a and 32a can be used to dispense a predetermined volume of liquid as follows. The lower apertures 264, 274 of the inner 256 and outer member 266 are aligned to define the passage 228. The container 200 is then tilted until the liquid in the main volume 232 reaches the passage 228 and flows into the reservoir 218. The container 200 is then tilted to an upright position with the reservoir axis Y vertically aligned so that the liquid in the reservoir 218 is at the level of the lip 226 of the passage 228 defining the pre-determined volume. The inner member 256 is then moved angularly around axis Y relative to the outer member 266 to occlude the passage 228 and align the upper apertures 260, 270 of the inner 256 and outer 266 member to define the outlet 208. The predetermined amount of liquid reservoir 218 can then be drained from the outlet 208 by tilting the container 200.

The upper and lower apertures 260, 270 of the inner member may be orientated at about 90°.

The outlet 208 of FIGS. 31a and 32a extends in a direction generally normal to the long axis of the reservoir member 220. This arrangement may provide a spout to facilitate dispensing the liquid from the container 200. Referring to FIGS. 31b and 32b, a top portion of the inner member has an elongate tab 276, which aligns with the direction of the spout when the upper apertures 260, 270 of the inner 256 and outer 266 members are aligned to define the outlet 208 of the container 200, thereby providing visual indication to a user that the outlet 200 is open.

The spout also provides a visual indication to a user which way the container is to be tilted to charge the reservoir 218. As the passage 228 is oppositely orientated to the spout, best charging results are achieved by tilting the container 200 toward the spout

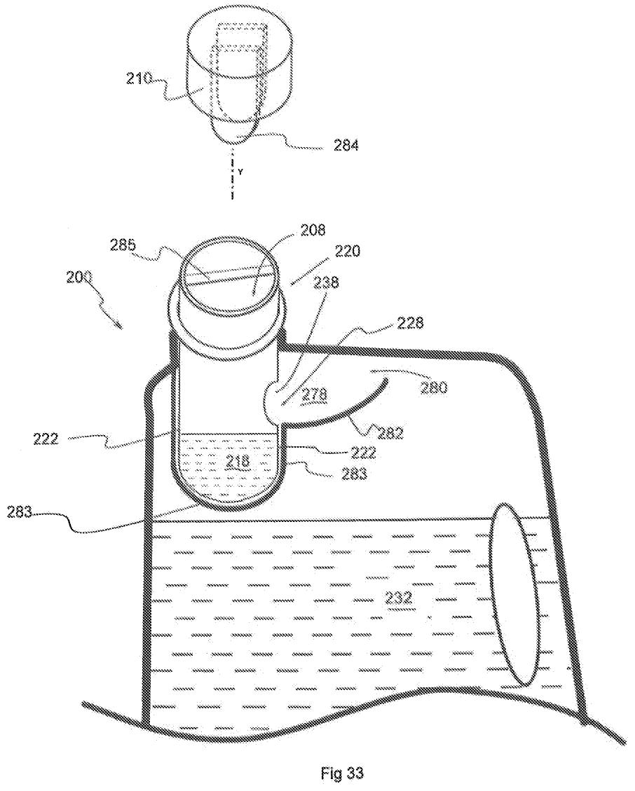

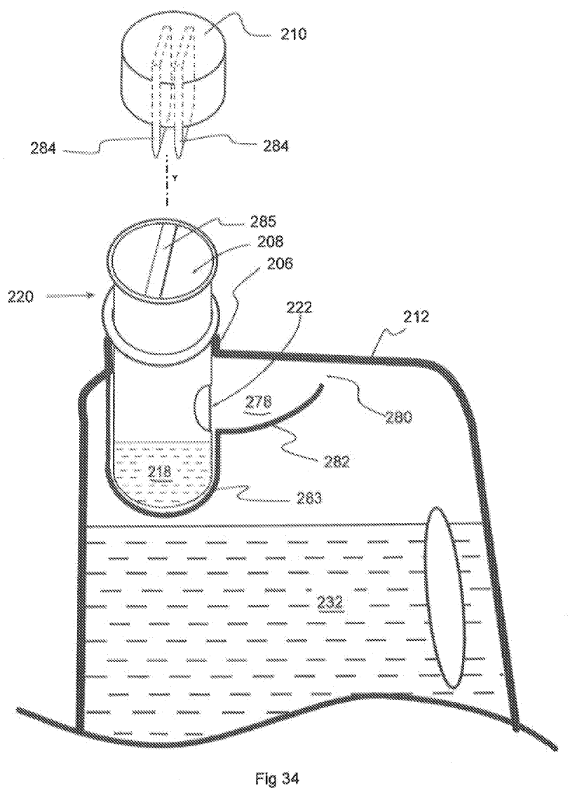

FIGS. 33 and 34 show an embodiment where the reservoir 218 member has a generally cylindrical configuration received through the neck portion 206. The reservoir member 220 is angularly movable about axis Y relative to the neck portion 206 to bring an aperture 238 in a side wall 222 of the reservoir member 220 into communication with a secondary reservoir 278 within the internal space 204 of the container 200, as shown in FIG. 33. The secondary reservoir 278 has a secondary passage 280 in communication with the main volume 232 of the container 200. The secondary reservoir 278 is formed by an internal wall 282 inclining upwardly, and a side wall 22 of the reservoir member. The internal wall 282 connects with further internal walls 283, the further internal walls 283 forming a pocket for receiving the reservoir member 220. Advantageously, the internal wall 282 and further internal walls 283 can be formed by crimping the hollow body 202 of the container 200, with the reservoir member 220 being formed separately.

In this embodiment, the reservoir member 220 can be moved angularly so that the aperture 238 is out of alignment with the secondary reservoir 278, and seals against some other part of the container 200 such that there is no passage 228 between the secondary reservoir 278 and the reservoir 218, as shown in FIG. 34. The container 200 can then be tilted so that liquid in the main volume reaches the level of the secondary passage 280 and flows into the secondary reservoir 278. The container is tilted again to its upright position so that the secondary reservoir 278 is charged to the level of the secondary passage 280 defining the predetermined volume. Then, the reservoir member 220 can be moved angularly to bring the aperture 238 into communication with the secondary reservoir 278, thereby defining a passage 228 into the reservoir 218 for the predetermined volume of liquid charged to the secondary reservoir 278. Opening said passage 228 allows liquid in the secondary reservoir 278 to drain into the reservoir 218 thereby charging the reservoir 218 with the predetermined volume of liquid. Once the predetermined volume of liquid is charged to the reservoir 218, the reservoir member 220 can moved angularly to occlude the passage 228 thus closing communication between the reservoir 218 and secondary reservoir 278. The container 200 can then be tilted to dispense the predetermined volume of liquid from an outlet 208 of the container 200 defined by an open top of the reservoir member 220.

In a preferred embodiment, the orientation of the secondary passage 280 is configured so that the liquid level in the main volume 232 reaches the secondary passage 280 when the container 200 is at the maximum dispensing angle required to dispense the entire predetermined volume from the reservoir. Then, when the container 200 is tilted to an upright position where the liquid in the main volume 232 is no longer at the level of the secondary passage 280, the secondary reservoir 278 is charged with the predetermined volume ready for charging to the reservoir 218 by opening the passage 228. Such an arrangement may be advantageous as charging the predetermined volume and dispensing the liquid can be performed with a single tilting action.

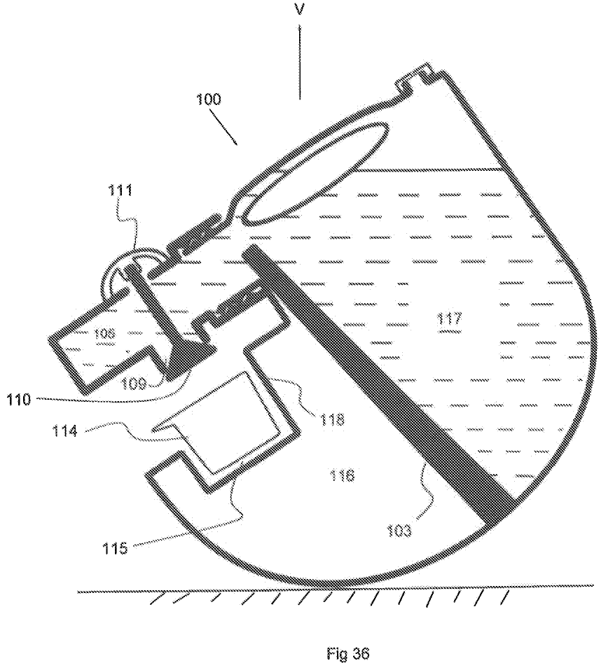

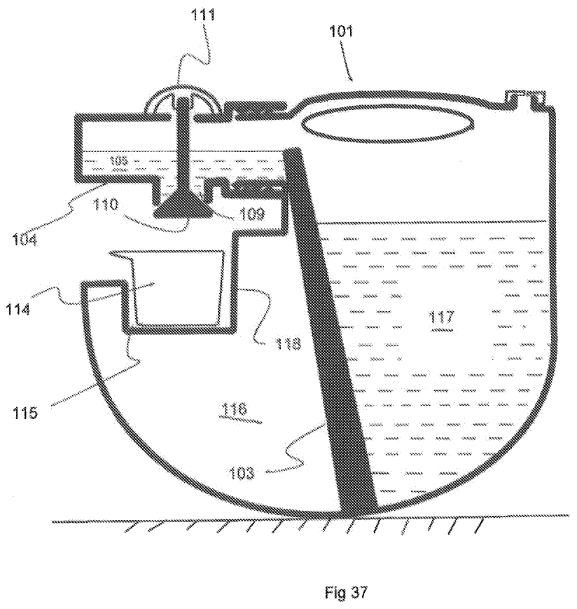

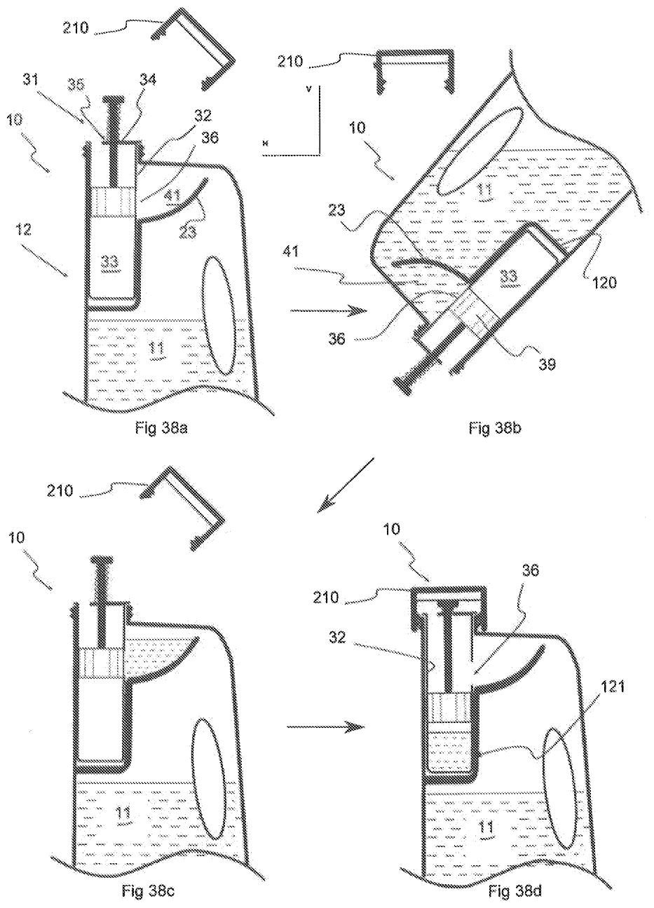

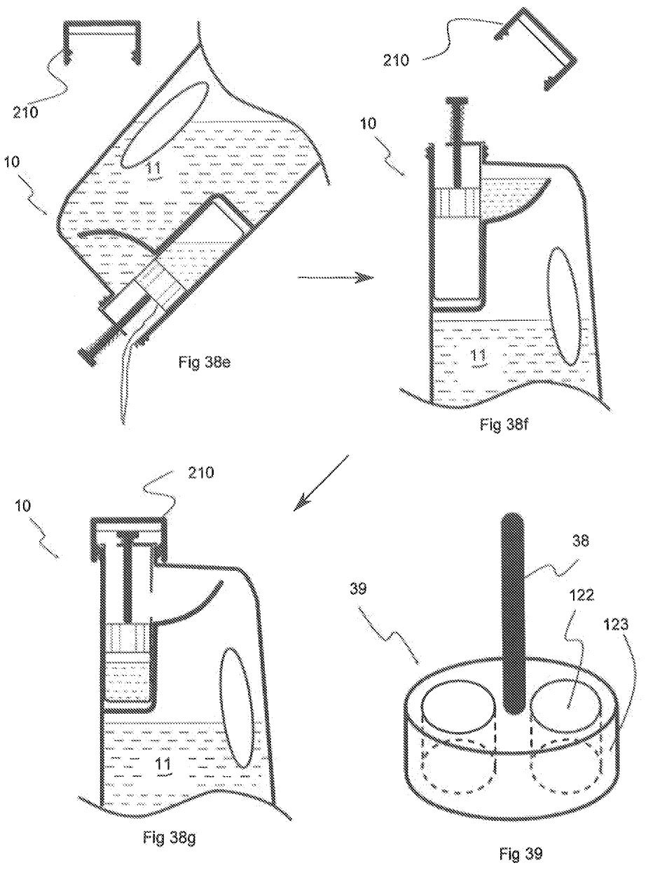

The cap of FIGS. 33 and 34 is configured to angularly move the reservoir member 220 as the cap 210 is engaged with the neck portion 206 of the container 200 to occlude the outlet 208. The cap 210 has an engagement feature in the form of prongs 284 for engaging a fixed portion 285 of the reservoir member 220, such that angular movement of the cap 210 to engage the internally threaded cap 210 with the externally threaded neck portion 206 will be couple to the reservoir member 220 to cause angular movement thereto. Here, the fixed portion 285 is a bar, and the prongs 284 will locate on either side of the bar 285 to engage therewith for coupled angular movement. The arrangement is configured such that when the cap 210 is fully engaged to the neck portion 206 the reservoir member 220 will be angularly moved to the position of FIG. 36 with the aperture 238 in communication with the secondary reservoir 278. When the cap 210 is removed from the neck portion 206 to open the outlet 208, the reservoir member 220 is moved to the position of FIG. 34 with the aperture 238 sealed from the second reservoir.

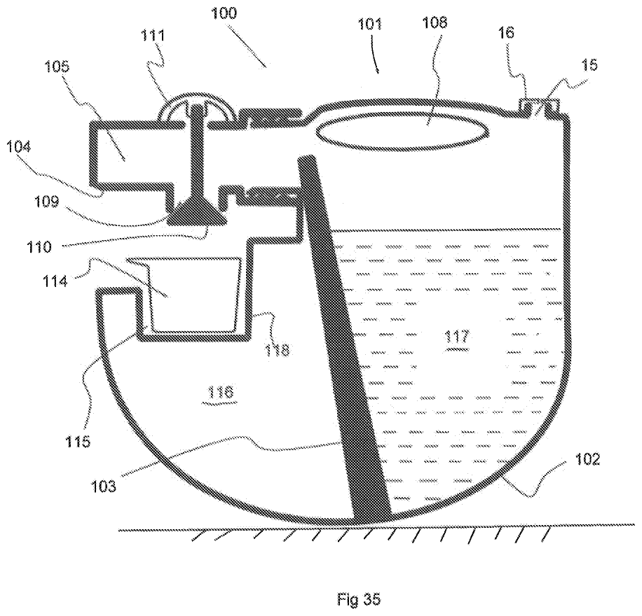

FIGS. 35 to 37 show a container 100 similar to that of FIG. 8, but adapted for dispensing a predetermined quantity of liquid to a receptacle 114. This container 100 includes a hollow body 101 that has a bottom wall 102 that is rounded over at least a portion to facilitate tilting, and flat over at least a portion to provide a stable surface for the container to rest. The body 101 is crimped to form a generally upright internal wall 103. The internal wall 103 separates a main volume 117 from a space 116 sealed from liquid within the main volume 117. The internal wall 103 partly encloses a first sub-chamber 105 from a main volume 117 of the container 100. An inlet port 15 is provided via which the liquid is delivered to the main volume 117. The port is closed by a cap 16.

The container 100 is provided with a handle 108.

A bottom wall 104 of the sub-chamber 105 is provided with a valve opening 109 that can be closed by movable valve member 110. The movable valve member is coupled at its upper end to a flexible cap 111 that can be depressed to move the valve member 110 from engagement with the wall 104 to open the valve opening 109.

The outer walls 118 defining the space 116 are shaped to form a depression 115 for receiving a receptacle 114.

In use, the movable valve member 110 is urged to close the valve opening 109 by the cap 111. When the valve opening 109 is closed, a user tilts the container 100 to cause the liquid 112 to flow from the main volume 117 to the sub chamber 105, as shown in FIG. 39.

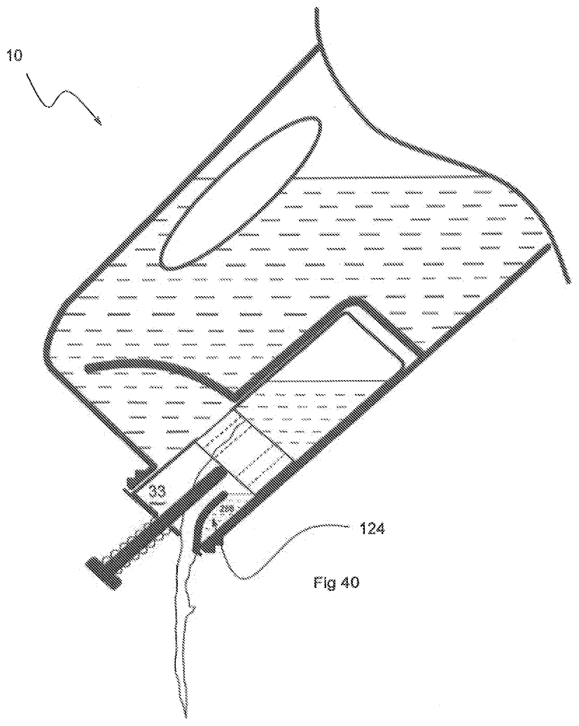

With the container 100 then upright as shown in FIG. 40, a user depresses the cap 111 to move the valve member 110 from the closed position to the open position in respect of the valve opening 109. Liquid in the sub-chamber 105 is then allowed to flow to a receptacle 114 received in the depression 115 beneath the valve opening 109.

The user then releases the cap 111, so that the valve opening 109 is then closed by the valve member 110.

By operation of the above described container 100, a user can charge the sub-chamber 105 with a pre-determined volume of liquid.

In an embodiment, the sub-chamber is non-opaque and marked with indicia 234 so that the pre-determined amount of liquid can be selected as hereinbefore described.

FIGS. 38a to 38g show an embodiment, similar to that of FIG. 1. Here the container 10 includes a hollow body 12 that provides a space to receive and store a liquid to be dispensed by the container.

The body 12 may be crimped to provide an internal wall 23 inclined relative to the horizontal H. The internal wall joins with further internal walls 120 defining a recess 121 for receiving a valve assembly 31. The valve assembly 31 includes a hollow chamber member 32 that surrounds and provides a chamber 33. The chamber member also has an end flange 34 having an aperture 35.

The outlet 29 is located adjacent the upper portions of the chamber member 32, while located at an intermediate portion is an inlet 36. Mounted by means of a stem 38, slidably located in the aperture 35, is a movable valve member 39. The movable valve member 39 is movable within the chamber member 32 to open and close the inlet 36. When the valve member 39 is in a closed position, internal wall 23 defines a sub-chamber 41, which can be charged with a pre-determined volume of liquid by tilting the container 10, and restoring the container 10 to an upright position as shown in FIGS. 38bb and 38cc.

With the sub-chamber 41 charged, the valve member 39 may be moved downwardly to open the inlet 36, with the liquid in the sub-chamber 41 flowing into a bottom portion of the chamber 33 via passages 122 though the valve member 39. This action is shown in FIG. 38d.

Then, the valve member 39 can be returned to the closed position, and the liquid dispensed from the chamber 33 by tilting the container 10. As the container 10 is tilted to dispense the liquid, liquid in the space 11 floods the sub-chamber 41 thereby charging the sub-chamber 41 when restored to the upright position, ready for charging to the chamber 33 by opening the valve member 39. This action is shown in FIGS. 38e to 38g.

FIG. 39 shows a valve member 39 suitable for use with the embodiments of FIGS. 38a to 39g, with the valve member 39 having a side portion 123 of sealing the inlet 36 of the chamber 33, and passages 122 facilitating flow of liquid within the chamber 33.

FIG. 40 shows an alternative embodiment of the chamber member 32 where a liquid trap 124 is formed in one side of the chamber 33 near the outlet 29. In this embodiment, the chamber 33 is angularly movable so as to move the liquid trap 124 into and out of the path of the liquid being dispensed, as selected by a user. If liquid is dispensed with the liquid trap 124 in the path of the dispensed liquid as depicted, a volume 286 of liquid is trapped within the liquid trap 124 and is not dispensed. If the liquid is dispensed with the liquid trap 124 rotated about of the path of the liquid, all or substantially all of the liquid charges to the chamber 33 will be dispensed. Alternative embodiments of FIGS. 28 to 35, for example, may include a liquid trap 124 so that the liquid trap 124 can be selectively located along the surface 30 to reduce the amount of liquid dispensed by the container by withholding the volume 286.

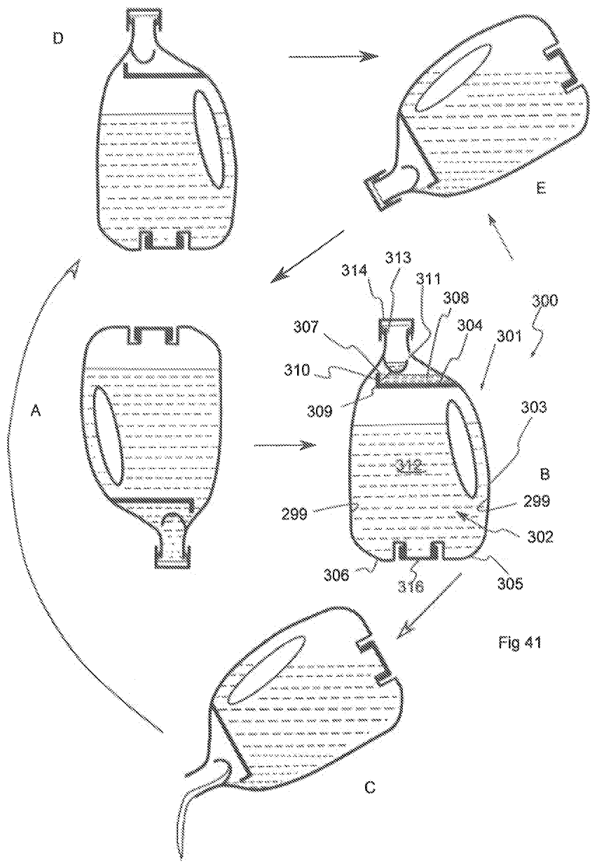

In FIG. 41 there is schematically depicted a container 300. The container 300 includes a hollow body 301 that encloses a major chamber 302. The body 301 includes an outer wall 303 that encloses the chamber 302. Extending inwardly of the chamber 302, from the wall 303 is a partitioned wall 304.

The outer wall 303 includes a bottom 305 that provides a surface 306 upon which the container 300 would normally rest so as to extend upwardly from the surface upon which it rests. In particular the wall 303 has upwardly extending side wall portions 299 that extending upwardly from the bottom 305.

The partition wall 304 has its major direction of extension generally parallel to the bottom 305. More particularly, and most preferably, the partition wall 304 extends generally parallel to the bottom 305.

The partition wall 304 includes an end lip 307 so that the partition wall 304, in cooperation with the side wall portions 299 provides a reservoir 308.

The body 301 further includes a further wall 309.

The partition wall 304 extends laterally from the side wall portions 306 so as to provide a passage 310, while there is also a passage 311 between the walls 309 and the side wall portions 304.

The partition wall 304 is above the bottom 305 when the container 300 is resting on a supporting surface, while the wall 304 is in-between the wall 309 and the bottom 305.

The major chamber 302 receives a volume of liquid 312 to be dispensed.

To provide for dispensing of the liquid 312, the body 301 is provided with a threaded neck 313 that is closed by means of a threaded cap 314.

In operation of the container 300, the container is inverted (position A) so that portion of the liquid 301 is located below the wall 304. Thereafter, the container is righted (position B) so that there is a volume of liquid retained by the reservoir 308, and a volume of liquid contained by the wall 309. Thereafter, the container 300 is inclined (position C) so that the liquid retained by the wall 309 is dispensed by the neck 313, while the liquid retained by the reservoir 308 returns to adjacent passage 310. Thereafter, the container 300 is righted (position D) so that it can rest on its surface 306. The liquid 312 is then contained so as to be totally below the wall 304. Again the container 300 is inverted (position E to position A) so that again a volume of liquid is located below the wall 304, that is retained in the body 301 by the cap 314. The cap 314 is returned to a position sealingly engaged with the neck 313 when the container 300 is righted to the position D. The sequence then can be completed.

In respect of the above preferred embodiment, when the container 300 is inclined so as to be located in the position C, the liquid level extends between the lip 307 and wall 309, so that air pressure on the liquid prevents further dispensing.

Preferably the body 301 is provided with a handle 315. Preferably the bottom 305 is provided with a filling portion 316 that provides for filling the container 300, and is closed once the container 300 is charged with liquid 312.

In the embodiments of FIGS. 9 to 40, the various containers described and illustrated are titled in a predetermined direction to provide for the measured volume to be dispensed. As illustrated, each of the containers includes a handle, that is gripped to aid in tilting the respective container. With reference to the particular Figures, the containers are moved angularly anti-clockwise, to provide for flow of liquid to the respective measuring chamber.

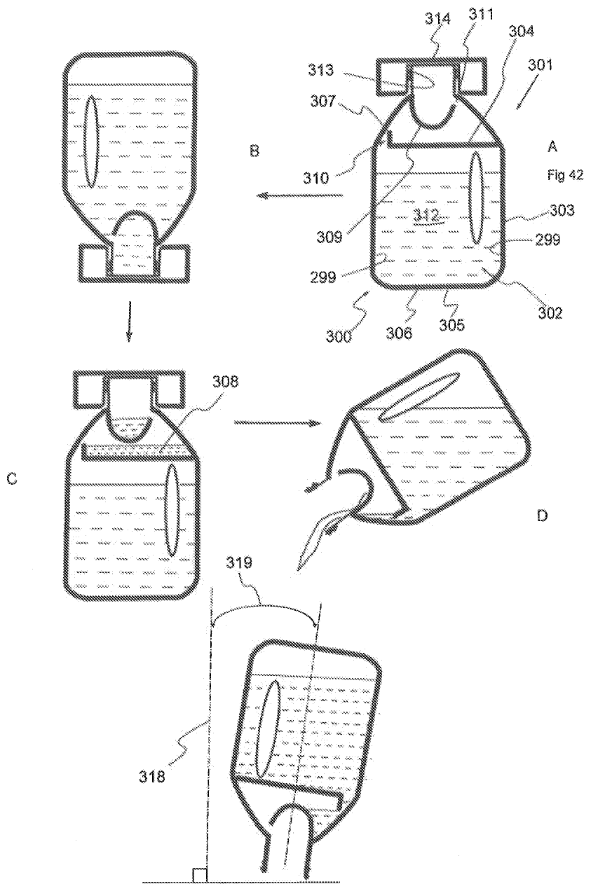

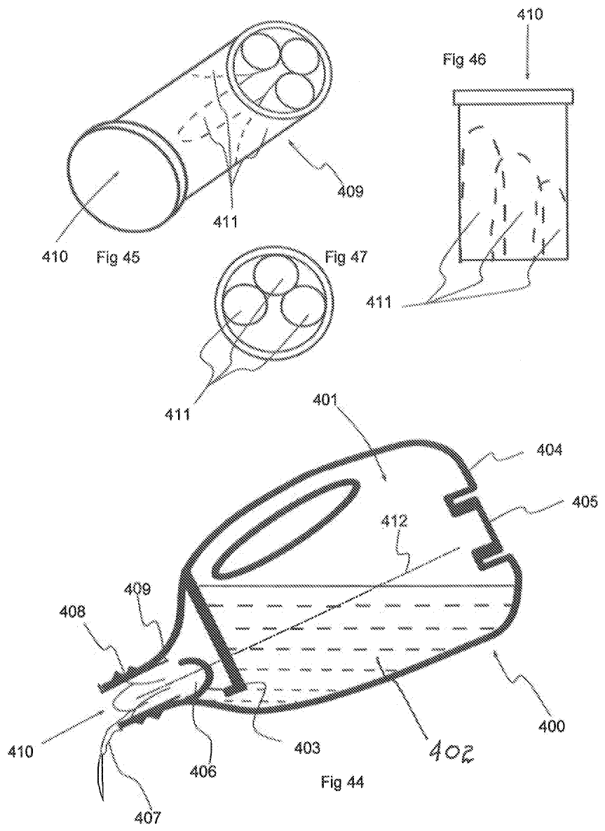

In FIG. 42 there is schematically depicted a modification of the container 300 of FIG. 44. In this embodiment the cap 314 is enlarged to provide for the container 300 to rest in an upright position on a surface 317 of the cap 314.

In the embodiment of FIGS. 41 and 42, the liquid 312 is best dispensed with the container 300 inclined to the vertical 318 by an acute angle 319.

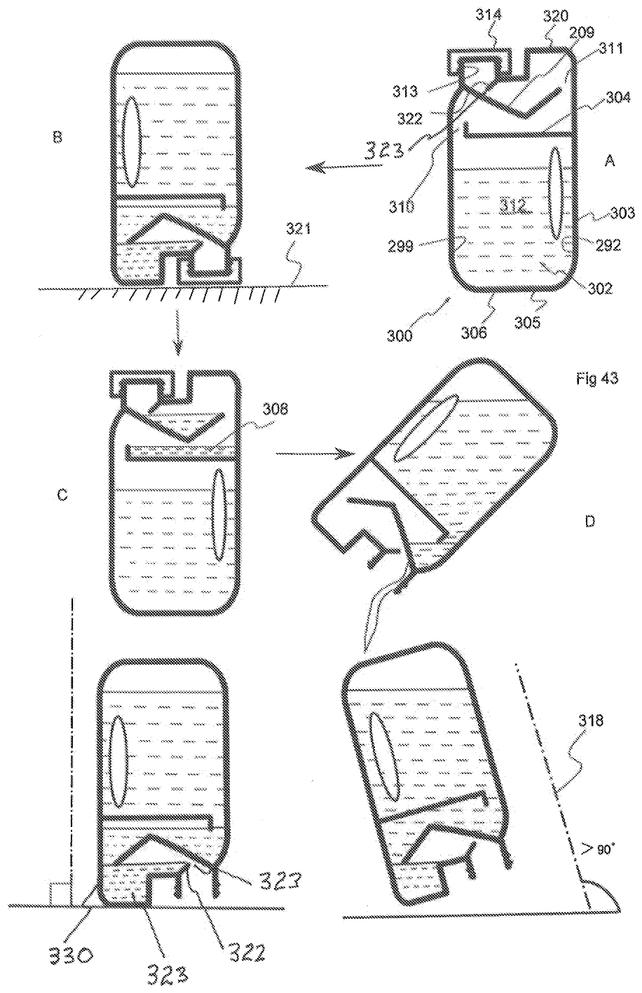

In the embodiment of FIG. 43, the container 300 starts in the position A, and moves to the position B to provide for the delivery of the liquid 312 to a position below the wall 304. The container 300 is then righted to the position C and moved to the inclined position D to provide for dispensing of the liquid 312.

In FIG. 43 there is schematically depicted a modification of the container 300 of FIGS. 41 and 42. In this embodiment the container 300 has a top wall portion 320 that cooperates with the cap surface 314 to provide a combined surface upon which the container 300 can rest so as to extend upwardly from a supporting surface 321.

Additionally, the container 300 includes a further wall 322 that extends from the top wall portion 320, adjacent the neck 313 to adjacent wall 309.

In operation of the container 300 of FIG. 43, it is essentially the same as operation of the container 300 of FIG. 42. However, in the embodiment of FIG. 43 the wall 322, and top wall 320, side wall portion 330 cooperate to provide a reservoir 323 when the container 300 is resting on the bottom wall 320. The wall 322 cooperates with the wall 306 to provide a liquid level, upon which air pressure is applied, to present the liquid being delivered to the neck 313 (to be dispensed). A passage 323 provides for delivery of the liquid from the reservoirs 323 to the neck 313 when the liquid is to be dispensed.

In the embodiments of FIGS. 41, 42 and 43, the container 300 dispenses a measured volume of the liquid 312, determined by the volume of the liquid contained by the wall 309._{[R1]}

In the embodiments of FIGS. 44 to 47, the container 400 includes a hollow body 401 enclosing a major chamber 402.

The body 401 includes side wall portions 403, with a partition wall 404 extending inwardly from the wall partitions 403 to divide the chamber 402.

The body 401 further includes a bottom wall portion 405, providing a surface 405 upon which the container 400 can rest so as to be upwardly extending from the supporting surface.

The wall portion 404 has its major direction of extension generally parallel to the surface 405, however the wall portion 403 is cupped so as to provide a measuring chamber 406 that can contain a volume of liquid 407.

The body 401 includes a neck 408 that may be threaded so as to receive a closing cap. Located internally of the neck 408 is a measuring sleeve 409. The sleeve 409 has a longitudinal central passage 410 via which the liquid is dispensed. However, the sleeve 409 includes three cavities 411 that are open toward the chamber 406, so that they can receive liquid therefrom.

The sleeve 409 is rotatable in the neck 408 about the longitudinal axis 412 to align a selected one of the cavities 411 with the reservoir 406.

The cavities 411 are of different volumes, accordingly, by selecting particular one of the cavities 411 with the chamber 406, the volume of liquid actually dispensed can be varied. For example, if none of the cavities 411 are aligned with the chamber 406, the full volume of liquid 407 stored by the chamber 406 is dispensed when the container 400 is inclined. However, by selecting one of the cavities 411, a certain portion of the liquid 407 is retained in the selected cavity 411, and returned to the chamber 406 when the container 400 is again righted to rest on the surface 405.

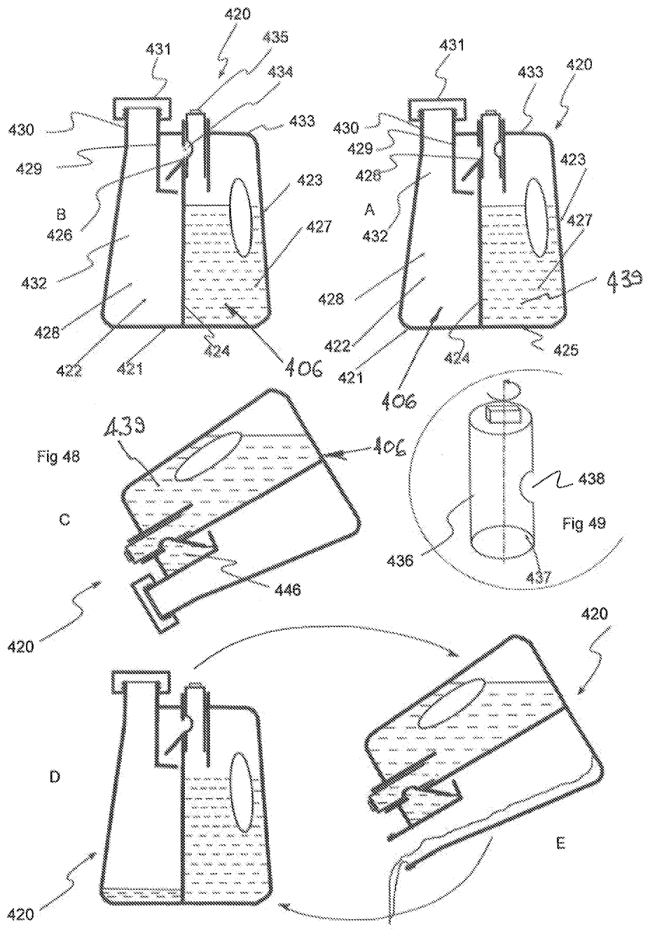

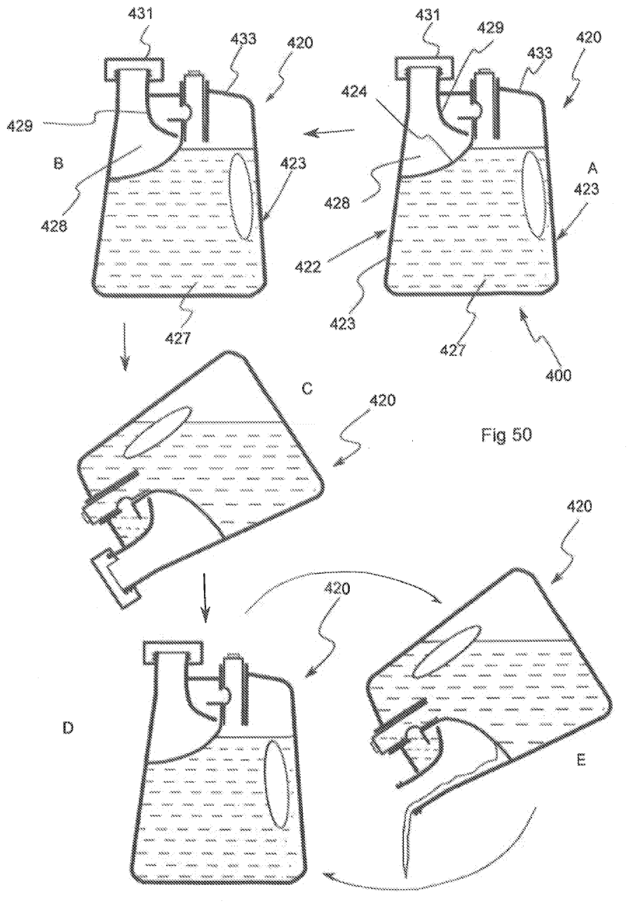

In FIGS. 48 and 50 there is schematically depicted a container 420. The container 420 includes a hollow body 421 enclosing a major chamber 422.

The body 421 has a side wall 423 surrounding the chamber 422, and an internal partition wall 424. The body 421 also includes a bottom wall 425, from which the wall 422 upwardly extends to an upper extremity 426.

The wall 424 divides the chamber 406 into a first sub-chamber 427 and 428.

The body 421 includes a still further internal wall 429, that extends from the neck 430 towards the bottom wall 425. The neck 430 can be threaded and may receive a cap 431.

The wall 429 and side wall 423 provide a dispensing passage 432.

Between the upper extremity 426, and the upper wall 433 is a passage 434 that selectively communicates with the sub-chamber 427 by means of a rotatable valve 435. The rotatable valve 435 has a cylindrical wall 436 providing a longitudinal passage 437 that communicates with the sub-chamber 427. The wall 436 has a side aperture 438 that is alignable with the passage 434, to provide for the flow of liquid 439 through the passage 434 to the sub-chamber 428.

The wall 429 provides a reservoir 446, that is charged when the container 420 is inclined (position C). However, upon the container 420 being inclined, the gap between the upper extremity 426 and the side wall 423 prevents liquid entering the sub-chamber 428. However, upon the container 420 being righted, the liquid in the reservoir 446 is delivered to the sub-chamber 428. This position D. Again the container 420 can be inclined so that the liquid stored in the sub-chamber 428 can be dispensed via the passage 432.

The rotatable valve 435 is closed, until the container 420 is to be first used. The valve 435 is turned so that the aperture 438 is aligned with the passage 434.

In the above described preferred embodiment, a measured volume of the liquid 439, determined by the shape of the wall 429, is dispensed.

In FIG. 50 there is schematically depicted a further modified container 420. In this embodiment, the wall 424 extends laterally from the side wall 423.

In FIG. 51 there is schematically depicted a container 450. The container 450 includes a hollow body 451 that provides a major chamber 452 that receives a liquid 453 to be dispensed.

The body 451 is also provided with a pouring lip 454 and a handle 455, with the handle 455 being diametrically opposite the pouring lip 454.

The body 451 also provides a socket 456 that receives a rotatable valve 457, with the valve 457 being received in the socket 456 so as to be angularly movable about the axis 458.

The socket 456 is closed to the chamber 452 apart from a socket passage 459 that can be selectively closed by the valve 457.

The valve 457 includes sub-chambers 460 and 461 separated by means of a dividing wall 462. The cylindrical side wall 463 is provided with a series of openings 464 that provide for selective communication with the passage 459, and the pouring lip 454.

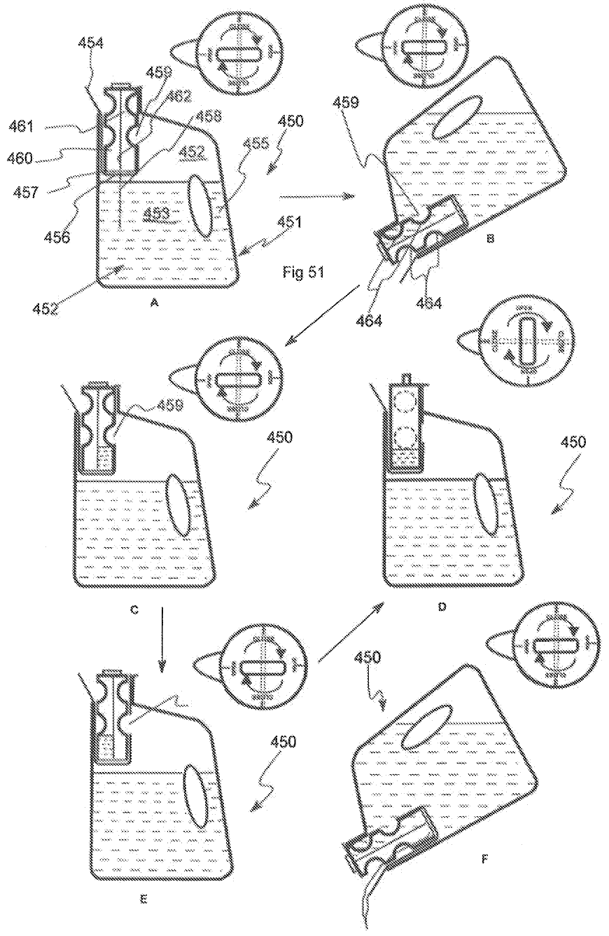

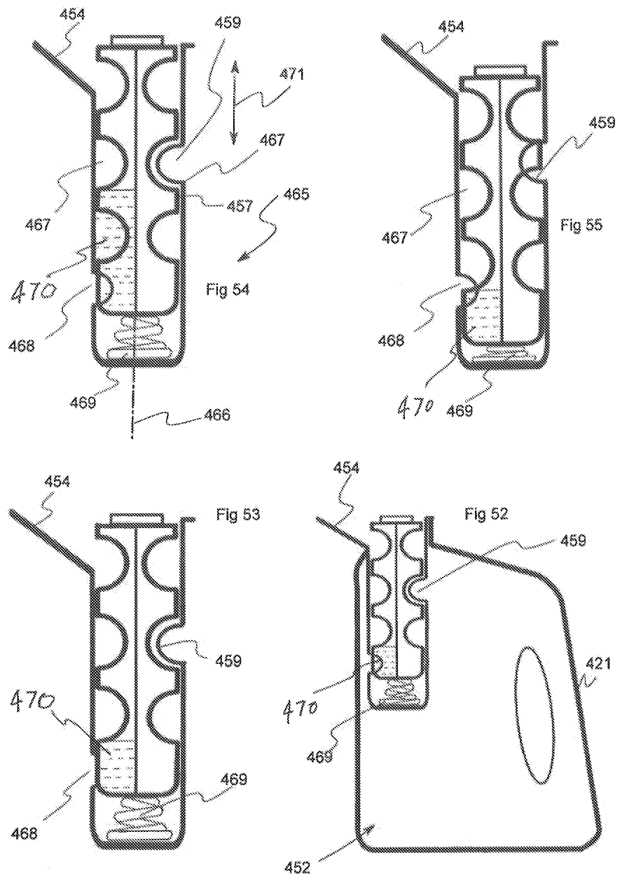

In a first position (position D) the valve 457 prevents communication between the chamber 452 at either of the chambers 460 and 461. However, upon moving the valve 457 angularly about the axis 458 to align a selected one or more of the openings 464 with the passage 459, a selected one of the sub-chambers 460 or 461 can be charged upon inclining the container 450 (position B or F). Thereafter, the container 450 can be righted and the valve 457 moved through 180° so that a selected one of the openings 464 can communicate with the pouring lip 545 to drain the charged passage 460 or 461. Upon tilting of the container 450 the charged chamber 460 or 461 is emptied, however the other chamber 460 or 461 is in communication with the chamber 452 and is charged. The wall 462 prevents continued flow of the liquid 453 from the chamber 452 to the pouring lip 454. The container 450 can again be used by tilting the container 450 again and rotating the valve 457 again through 180°. If the valve 457 is rotated only through 90°, none of the openings 464 have access to the pouring lip 454, accordingly no liquid is dispensed. The container 450 of FIG. 51 may also be provided with the valve assembly 465 of FIGS. 52 to 55.

The valve assembly 465 of FIGS. 52 to 55 includes the rotatable valve 457 that is movable in the direction 471 that generally parallel to the axis 466 about which the movable valve member 457 can be angularly moved. The valve member 457 is movable between a position as shown in FIG. 54, and a position as shown in FIG. 55. Additionally, the movable valve member 457 is provided with an additional intermediate aperture 467, that can be selectively aligned with the aperture 468 in the socket 456 so that an intermediate volume of liquid may be dispensed, by depression of the spring 469. By depressing a spring 469, a volume 470 can be provided as liquid above the volume 470 is drained via the aperture 468 to the main chamber 452.

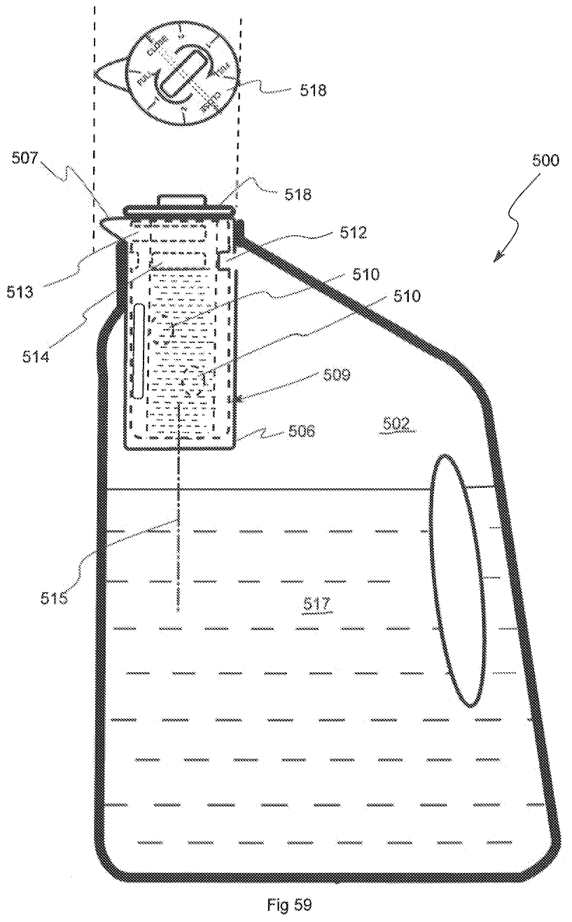

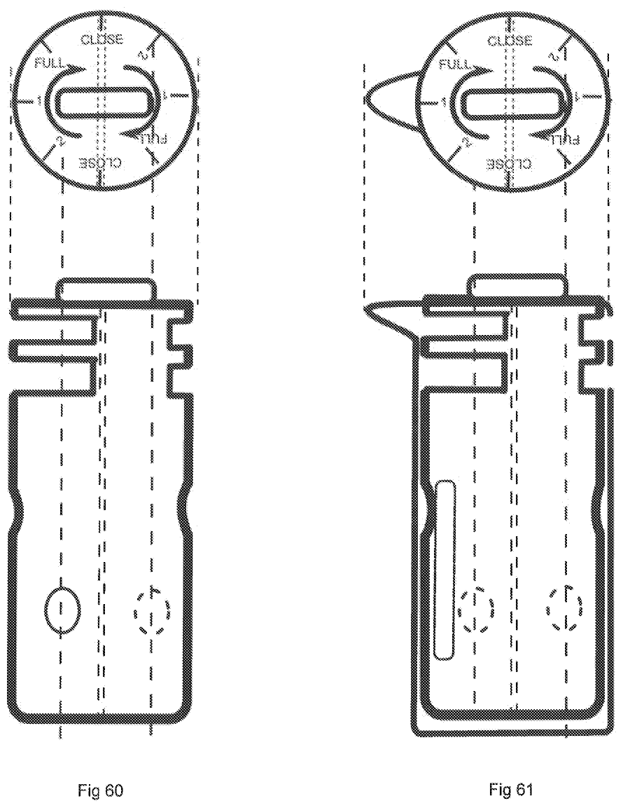

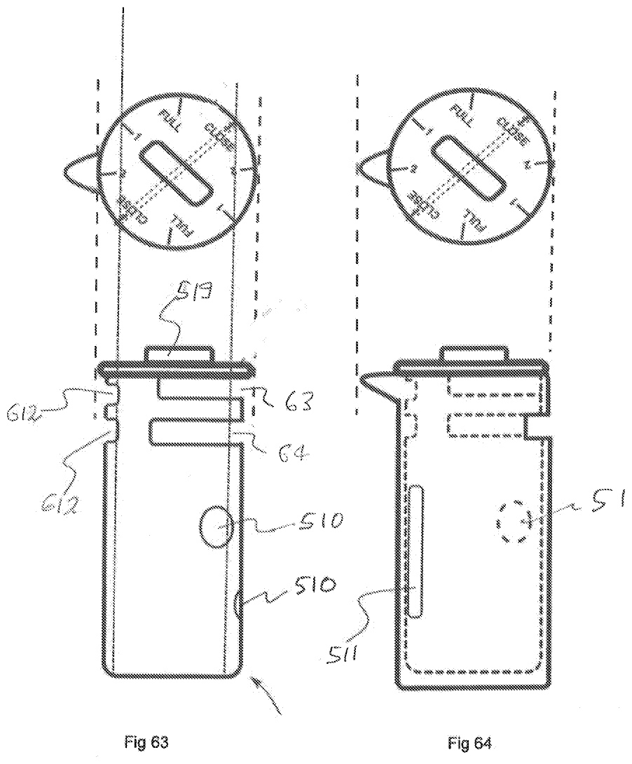

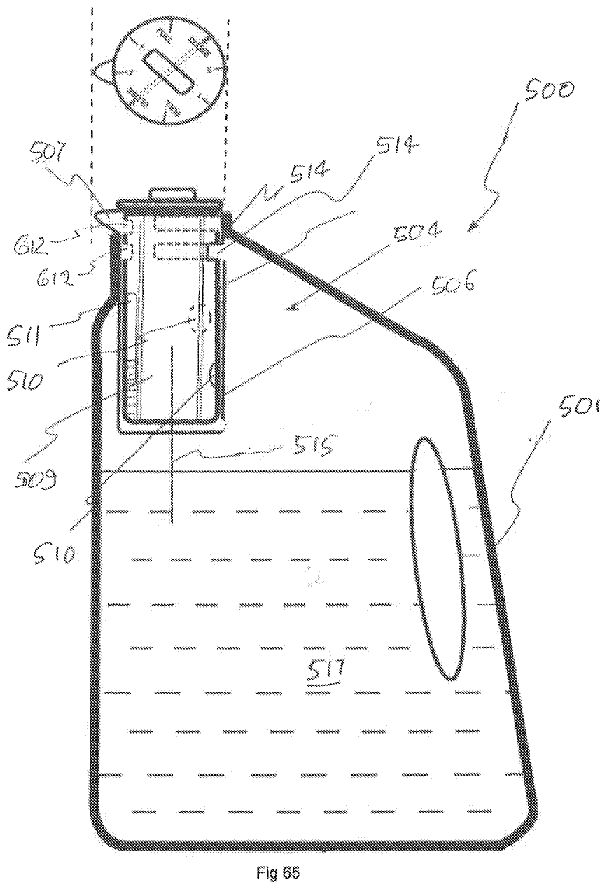

In FIGS. 56 to 65 there is schematically depicted a container 500. The container 500 includes a hollow body 501 providing a main chamber 502 that receives a liquid to be dispensed. The container 501 has an upper opening 503 that receives a valve assembly 504 secured to the lip 505 of the container 501 that surrounds the opening 503.

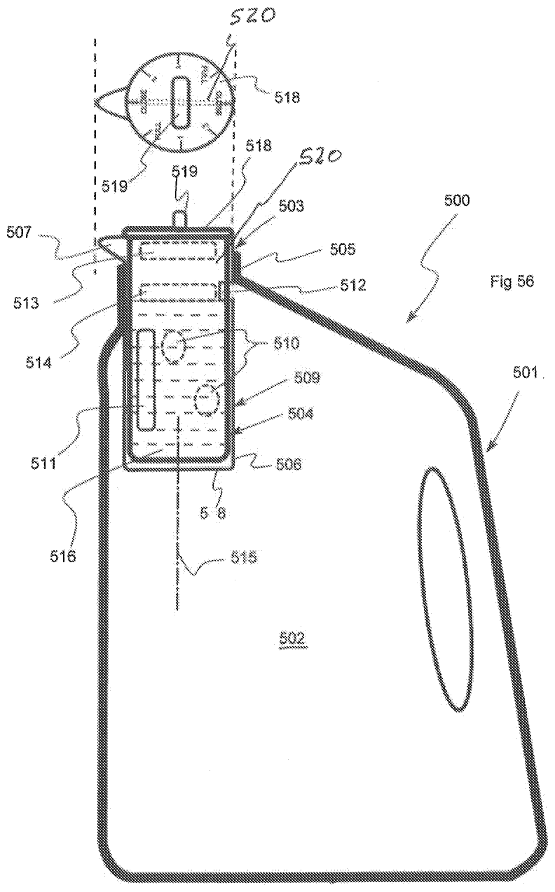

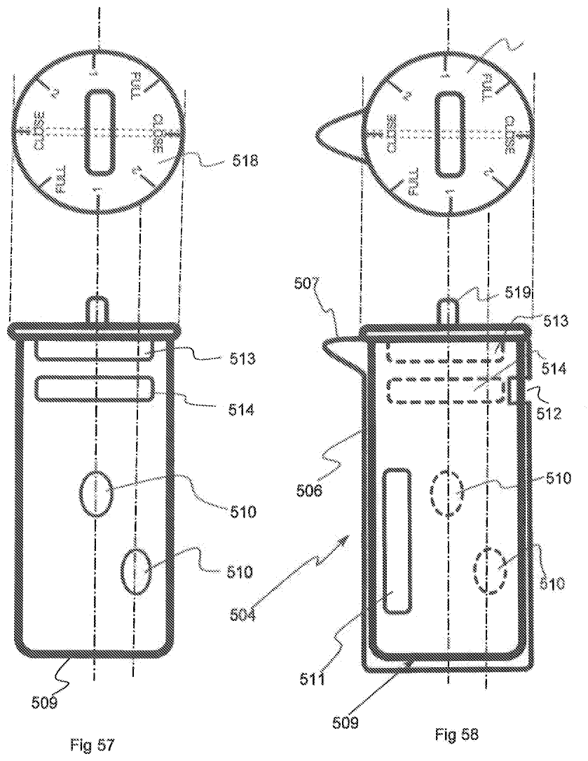

The valve assembly 504 is more fully depicted in the following FIGS. 57 and 58.

The valve assembly 504 includes an outer sleeve 506 that is provided with a pouring spout 507. The sleeve 506 is located within the rim 505 and is secured thereto so as to be stationary relative to the rim 505. The sleeve 506 is closed at its lower end by a transverse wall 508.

Located internally of the sleeve 506 is a movable valve member 509.

The sleeve 506 has at least two apertures 510 located at spaced positions along the sleeve 506, as well as a longitudinally extending slot 511 and a transverse slot 512. The slot 512 is located adjacent but slightly below the spout 507.

The movable valve member 509 includes a pair of transverse slots 513 and 514 in addition to the transverse slot 512.

The slot 513 and 514 are spaced 90° about the axis 515 relative to the slot 512.

The valve member 509 is hollow and enclosing a chamber 516 that is to receive a liquid 517.

The movable valve member 509 is closed at its upper end by means of a cap 518 that is provided with a handle 519, so that a user may grip the handle 519 and cause angular movement of the valve member 509 about the axis 515, to selectively align the slot 511 with a selected one of the apertures 510, and to selectively align the slot 512 with the slot 514.

The valve member 509, is moved about the axis 515 by a user gripping the handle 519 and causing the valve member 509 to move angularly.

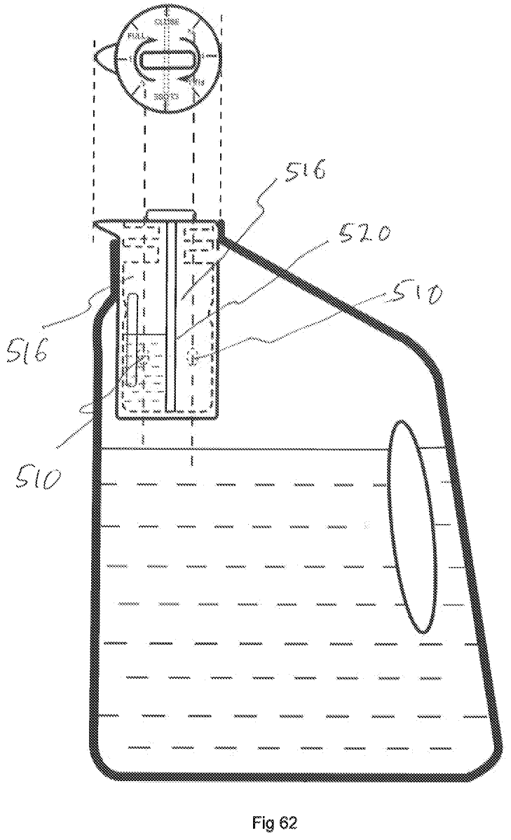

The dividing wall 520 (FIG. 62) divides the valve member 509 internally into sub-chambers 516. Each of the sub-chambers 516 is provided with a pair of respective apertures 510, each aperture 510 corresponding to a respective position of the cap 518. That is, the positions “1” and “2” have a corresponding aperture 510.

The cap 510 when in the closed position or full position prevents liquid entering either of the sub-chambers 516 or exiting from the sub-chambers 516.

Angular movement of the valve member 509 about the axis 515, will align a selected one of the apertures 510 with the slot 511, so that liquid is drained from the respective sub-chamber 516 to drain liquid therefrom so that a desired volume of liquid can be dispensed.

The valve member 509 is movable between, in this embodiment, between the closed position, and a full position. In the closed position no liquid can be dispensed, while in a selected one of the full positions liquid contained in one of the sub-chambers 516 can be dispensed. In that regard, the valve member 509 can be located in a selected one of a number of positions so that a desired particular volume of liquid can be dispensed.

In operation of the above discussed container 500, a user manipulates the body 501 so that the slot 512 is submerged. When the slot 514 is aligned with the slot 512, liquid is allowed to enter the chamber 516. When the container 500 is then righted, a selected one of the apertures 510 can be aligned with the slot 511, thereby draining liquid to a desired level. If none of the apertures 510 are aligned with the slot 511, a full measured volume is dispensed. If the lower of the apertures 510 is aligned with the slot 511, the smallest amount of the liquid is dispensed.

The liquid is dispensed by again causing angular movement of the valve member 509, so that the slot 513 is aligned with the spout 507. The liquid remaining in the chamber 516 can then be dispensed by tilting the container 500.

The movable valve member 509 can be modified to include an internal divider 520_{[R2]SO} that two chambers 516_{[R3]} are provided. One of the chambers 516 can dispense a full volume from the particular chamber 516, while the other chamber 516 may include one or more apertures 510.

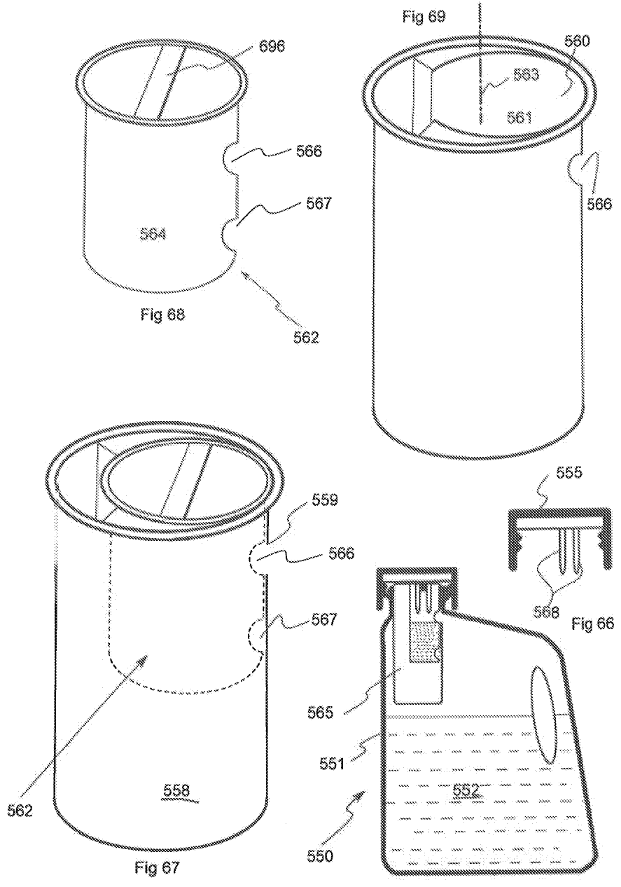

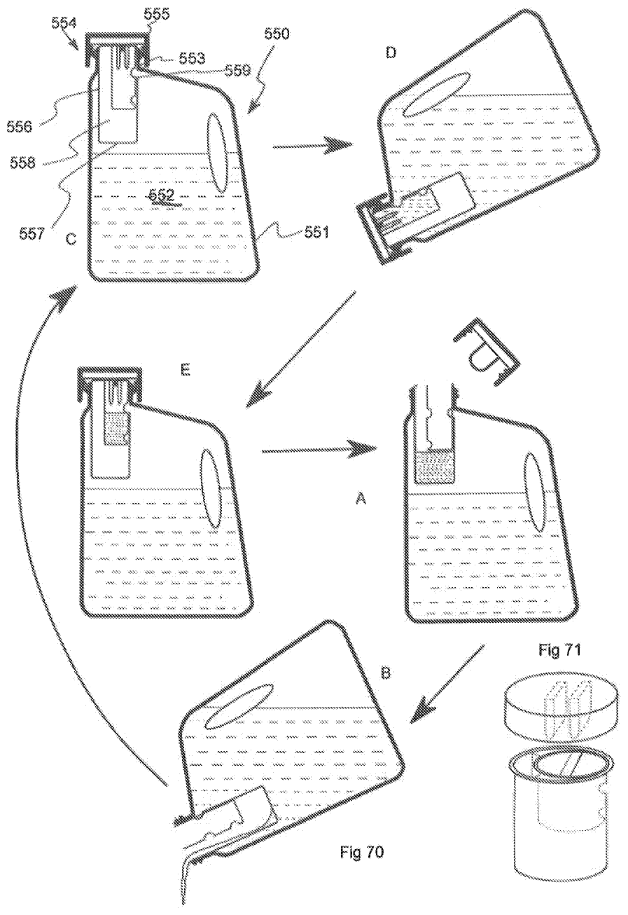

In FIGS. 66 to 71 there is schematically depicted a container 550. The container 550 includes a hollow body 551 that contains a liquid 552 to be delivered from the container 550.

The body 551 includes a neck 553 that receives a valve assembly 554. A cap 555 threadably engages the neck 553 to close the neck 553.

The valve assembly 554 includes an outer cylindrical sleeve 556 that fits in the neck 553 and is secured thereto so as to project inwardly of the body 551.

The sleeve 556 is open at its top end, is closed at its lower end 557 so as to substantially surround a chamber 558. The sleeve 556 has a side opening 559 that provides for liquid communication between the interior of the body 551 and the chamber 558.

Attached to or formed integral with the sleeve 556 is a movable valve mounting portion 560 that has an inner surface 561 that is part of a cylinder.

Received in the mounting portion 560 is a movable valve member 562 that is angularly movable about the central longitudinal axis 563 of the surface 561.

The movable valve member 562 has an outer cylindrical surface 564 that slidably engages the surface 561 to provide for the abovementioned angular movement.

The member 562 is hollow so as to provide an internal chamber 565, with the member 562 having openings 566 and 567.

The opening 566 is positioned so as to be alignable with the opening 559. Accordingly, by angular movement of the member 562, the opening 566 may be selectively aligned with the opening 559 to provide for the flow of the liquid 552 into the chamber 565.

When the opening 566 is aligned with the opening 559, the opening 562 is closed. However, upon moving the valve member 562 angularly about the axis 563, the opening 567 can be exposed to the chamber 558 to provide for delivery of liquid from within the chamber 565, to the chamber 558. Accordingly, upon removal of the cap 555, the contents of the chamber 558 can be dispensed.

Preferably the cap 555 has a pair of projections 568 that projects sufficiently to be engageable with a transverse bar 696 of the member 562, so that by manipulation of the cap 555, the member 562 can be moved angularly, when the cap 555 is not in threaded engagement with the neck 553.

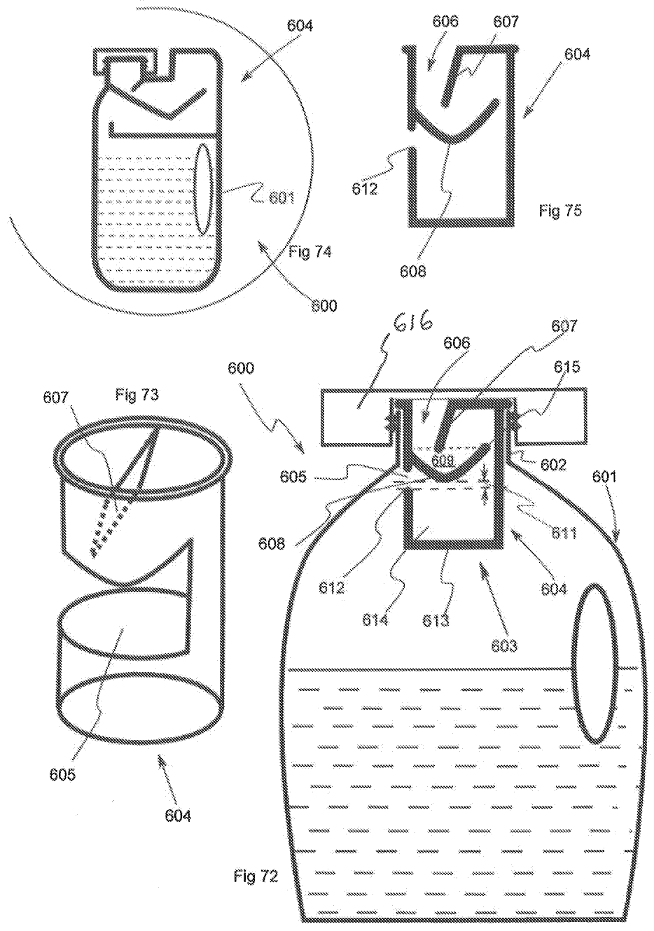

In FIGS. 72 to 75 there is schematically depicted a container 600. The container 600 includes a hollow body 601 having a neck 602.

Associated with the neck 602 is a liquid measuring member 603. The member 603 includes a generally cylindrical outer body 604 that is hollow, and has a side opening 605. The body 604, by being hollow, provides a chamber 606.

Projecting inwardly from the outer body 604 is a first flange 607 and a second flange 608.

The wall 608 provides a reservoir 609, that retains the liquid when the container 600 is resting on its base and generally upwardly extending. The flange 608 has a lower extremity 610 that is spaced by a distance 611 above the upper extremity 612 of the openings 605.

The outer body 604 is on a tubular form and closed at its lower end by means of a transverse wall 613 that is below the extremity 612, so that the outer body 604 provides a reservoir 614. The reservoir 614 is below the extremity 612.

A passage 615 between the flange 608 and body 604 provides for the flow of the liquid from the reservoir 614 to the reservoir 609.

The flange 601 projects downwardly towards the reservoir 607 and terminates at approximately the upper level of the reservoir 609, but permits the flow of liquid from the reservoir 609 to exit via the neck 602.

Threadably engaged with the neck 602 is a cap 616.

In the above described preferred embodiment, the body 604, may be integrally formed and inserted in the neck 602. As an alternative construction, the body 604 may be integrally formed with the body 601.

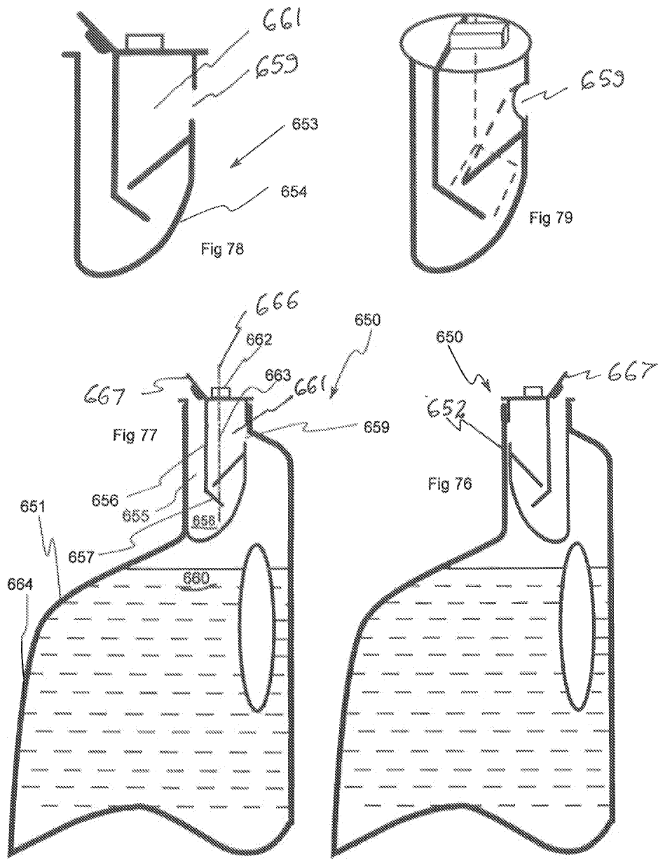

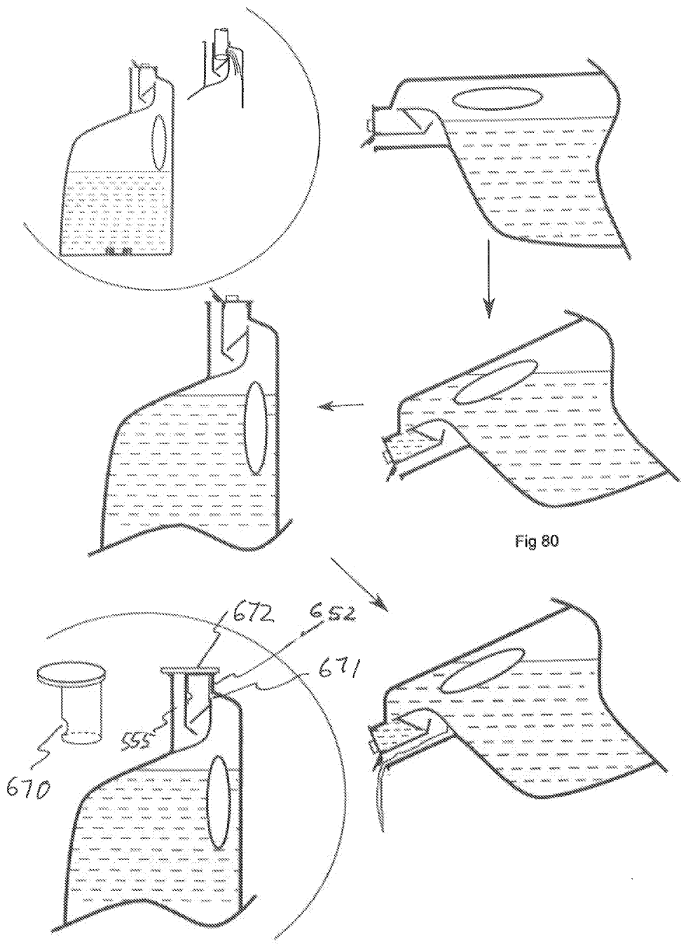

In FIGS. 76 to 79 there is schematically depicted a container 650. The container 650 includes a hollow body 651 having a neck 652. Inserted in the neck 652 so as to be secured therein is a measuring member 653. The member 653 includes an outer generally cylindrical body 654 that provides an outlet passage 655. The passage 655 is at least partly provided by an internal flange 656 that terminates at its lower end with a lip 657. Located below the lip 657 is a passage 658.

The body 654 has a side opening 659 that provides for communication between the internal space 660, and an internal cavity 661 of the body 654.

At its upper end the cavity 661 is closed by a transverse wall 662, so that the flange 656, lip 657 and wall 662 provide a reservoir 663, when the container 650 is oriented so that its side wall 664 is extending generally horizontal.

When the container 650 is inverted, the liquid 665 passes through the opening 659 to fill the cavity 661. Thereafter, when the container 650 is righted, the liquid flows into the passage 658 and passage 655. When the container 650 is again inclined, the measured liquid exits the passage 655 via the neck 652.

The measuring member 653 is rotatable about the axis 666 between a position allowing the reservoir 663 to be charged, and a position at which the opening 659 is closed (FIG. 80) at which liquid may then be dispensed through the outlet passage 659, without liquid entering the reservoir 663. A lid 667 is operable to close the passage 665 during charging of the reservoir 663.

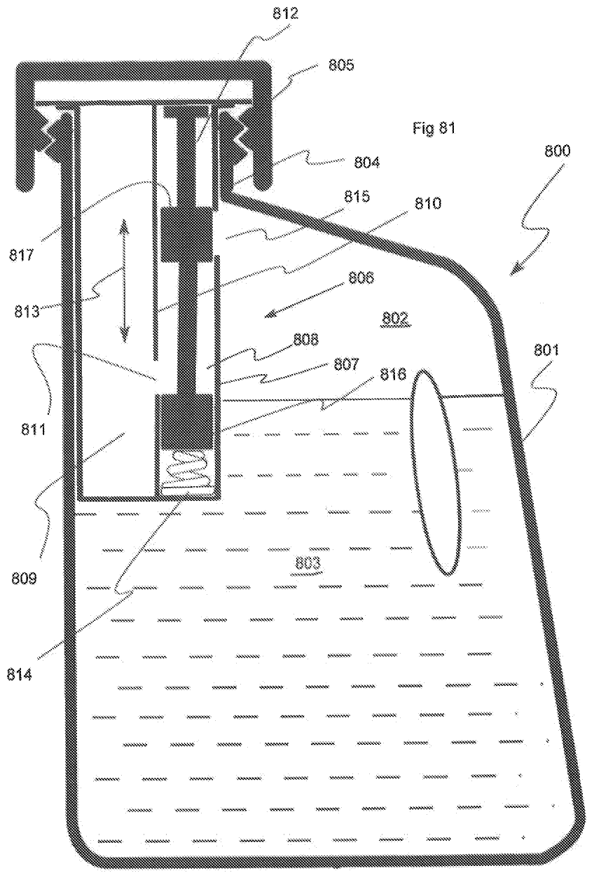

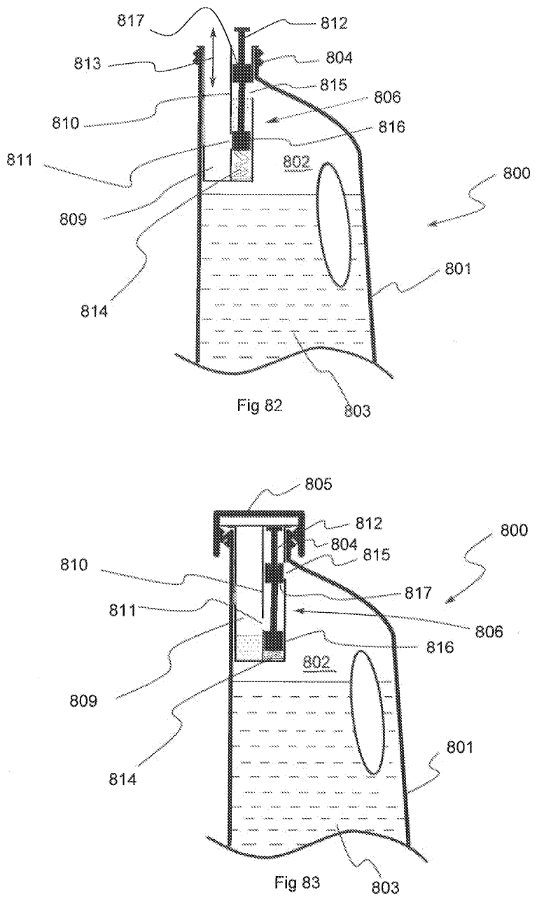

In FIGS. 81, 82 and 83, there is schematically depicted a container 800. The container 800 includes a hollow body 801 enclosing a chamber 802 that receives a liquid 803. The body 801 provides a threaded neck 804 that receives a threaded cap 805, as well as receiving a valve assembly 806. The valve assembly 806 includes a sleeve 807 fixed to the neck 804 and extending into the chamber 802, and then closes a first sub-chamber 808 and a second sub-chamber 809 separated by a dividing wall 810. The dividing wall 810 includes an aperture 811 that provides for communication between the sub-chambers 808 and 809.

Located in the sub-chamber 808 is a movable valve member 812 that is movable in the direction 813 but is urged upwardly by a spring 814 engaging a lower end portion of the movable valve member 812.

The sleeve 807 includes an aperture 815 providing for the liquid 803 to move from the chamber 802 to the sub-chamber 808.

The end portion of the movable valve member 812 engaged by the spring 814 is provided with a valve portion 816 that is alignable with the aperture 811, while the movable valve member 812 further includes a further valve portion 817 that is alignable with the aperture 815.

When the cap 805 is threadably engaged with the neck 804, the cap 805 locates the movable valve member so that the valve portion 817 closes the aperture 815. However, upon removal of the cap 805, the spring 814 moves the movable valve member 812 to a position at which the valve portion 816 closes the aperture 811 while the movable valve member locates the valve portion 817 at a position allowing liquid to flow through the aperture 815 from the chamber 802 to the sub-chamber 808. Accordingly, a liquid is delivered to the sub-chamber 808 (FIG. 83). Thereafter, the cap 805 can be again located on the neck 804, moving the valve portion 817 to close the aperture 815, while moving the valve portion 816 to expose the aperture 811. The liquid then flows to the sub-chamber 809. Again by removal of the cap 805, the aperture 811 is closed and the aperture 815 opened, and the liquid can be delivered from the sub-chamber 809. Accordingly, by manipulation of the movable valve member 812, a predetermined volume of liquid can be delivered by the container 800.

With reference to FIG. 80, in this embodiment, the measuring member 653 is formed by crimping the body 651 adjacent the neck 652.

Again with reference to FIG. 80, and in particular the lower left hand illustration, the measuring member 653, is again rotatably mounted in the neck 602, with the measuring member 652 being movable to a position providing alignment of the passage 670 with the aperture 671 to provide for charging of the member 656, at which position the upper cap 672 closes the neck 652. Upon further angular movement of the member 652, the passage 655 is exposed so that the liquid to be dispensed, with the aperture 670 not aligned with the aperture 671, so that further liquid cannot enter the member 652.

In the embodiment of FIGS. 81, 82 and 83, the container 800 is provided with a handle so that a user can rotate the container 800 anti-clockwise (with reference to the particular Figures) to charge the valve assembly 806 with the liquid to be dispensed.

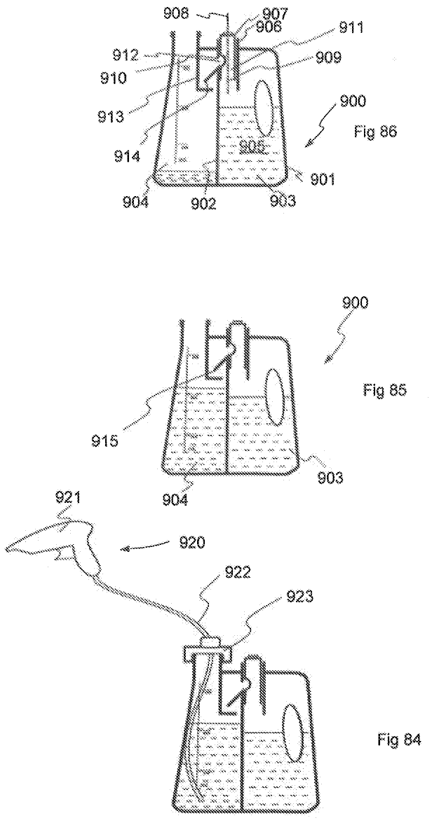

In FIGS. 84, 85 and 86, there is schematically depicted a container 900. The container 900 includes a hollow body 901 that encompasses a chamber, divided by means of a wall 902 into a first sub-chamber 903 and a second sub-chamber 904. The sub-chamber 903 receives a volume of liquid 905.

The body 901 further includes a neck 906 provided by an elongated sleeve that slidably receives a movable valve member 907. The movable valve member 907 is movable angularly about an axis 908 relative to the neck (sleeve) 906.

The neck (sleeve) is provided with a lower aperture 909, and a side aperture 910. The movable valve member is also provided with an end aperture 911 and a side aperture 912. The movable valve member 907 is movable angularly about the axis 908 to selectively align the apertures 910 and 912, when the liquid 905 is to be transferred to the sub-chamber 904.

Located internally of the sub-chamber 904, is an internal wall 913 that cooperates with a flange 914 to measure a predetermined quantity of liquid to be delivered from the sub-chamber 903 to the sub-chamber 904. The wall 913 and flange 914 provide a passage 915 to provide for the delivery of the liquid to the sub-chamber 904.

Optionally, the container 900 may be provided with a spray attachment 920. The attachment 920 includes a trigger operated dispenser 921 that when operated provides a spray or stream, with the dispenser 921 connected to the container 900 by means of a tube 922. The container 900 would be provided with a cap 923 through which the tube 922 would pass so that the end extremity of the tube 922 is located at the lower portion of the sub-chamber 904.

In this embodiment a predetermined volume of liquid 905 can be dispensed from the sub-chamber 903, to the sub-chamber 904, so that water may be then added to the sub-chamber 904 for correct volumetric mixing of the liquid 905 with water or other flowable substance.

1.-11. (canceled)

12. A container to dispense a predetermined volume of a flowable substance stored in the container, the container including:
a lid;
a hollow body having an interior space to store the substance;
an outer wall including a base;
a partition wall arranged to extend from the outer wall across the interior space so as to create a passageway into a second interior space; and
a liquid retaining wall arranged to receive, define and dispense the predetermined volume of a flowable substance in use, wherein the liquid retaining wall is spaced from the partition wall so as to exert pressure on fluid in the interior space towards the base.

13. The container of claim 12, wherein the partition wall includes a lip.

14. The container of claim 12, wherein the liquid retaining wall and partition wall are relatively positioned so that fluid in the second interior space that is not in the liquid retaining wall flows into the passageway when the container is poured.

15. The container of claim 12 wherein the partition wall extends generally parallel to the base.

16. A container to dispense a predetermined volume of a flowable substance stored in the container, the container including:
a lid;
a hollow body having an interior space to store the substance;
an outer wall including a base;
a partition wall arranged to extend from the outer wall across the interior space so as to create a passageway into a second interior space;
a liquid retaining wall arranged to receive, define and dispense the predetermined volume of a flowable substance in use; and
an upper wall arranged to provide a reservoir, wherein the reservoir is arranged to exert pressure on fluid in the interior space towards the base.

17. The container of claim 16, wherein the reservoir is arranged to provide fluid to the liquid retaining wall.

18. The container of claim 16 wherein the reservoir is defined by the upper wall, the side wall portion of the hollow body and a neck wall.

19. The container of claim 16, wherein the liquid retaining wall and partition wall are relatively positioned so that fluid in the second interior space that is not in the liquid retaining wall flows into the passageway when the container is poured.

20. A container to dispense a predetermined volume of a flowable substance stored in the container, the container including:
a lid,
a hollow body having an interior space to store the substance;
an outer wall including a base;
a partition wall arranged to extend from the base through the interior space so as to create a passageway into a second interior space, wherein the passageway includes a valve;
a liquid retaining wall arranged to receive, define and dispense the predetermined volume of a flowable substance in use;
wherein the predetermined volume of a flowable substance is arranged to pass through the valve into the liquid retaining wall when the container is tilted; and
wherein the predetermined volume of flowable substance is arranged to pass from the liquid retaining wall into the second interior space ready to be poured when the container is placed vertically in use.

21. The container of claim 20, wherein the valve is rotatable.

22. The container of claim 20, wherein the liquid retaining wall includes a wall extending from the container outlet.

23. The container of claim 20, wherein the liquid retaining wall includes a wall angled into the second interior space.
